(19) United States
(12) Patent Application Publication
(10) Pub. No.: US 2021/0397745 A1
(43) Pub. Date: Dec. 23, 2021

(54) DATA PROVIDING SERVER DEVICE AND DATA PROVIDING METHOD

(71) Applicant: Hitachi, Ltd., Tokyo (JP)

(72) Inventors: Yohsuke ISHII, Tokyo (JP); Tsuyoshi TANAKA, Tokyo (JP); Kazuhiko MIZUNO, Tokyo (JP)

(21) Appl. No.: 17/196,048

(22) Filed: Mar. 9, 2021

(30) Foreign Application Priority Data
Jun. 18, 2020 (JP) 2020-105301

(51) Int. Cl. G06F 21/62; G06F 16/28; G06F 16/2457; G06F 16/22

(52) U.S. Cl. CPC G06F 21/6254; G06F 21/6227; G06F 16/221; G06F 16/24573; G06F 16/282

(57) ABSTRACT

When anonymized data is used for data analysis purposes, it is required to try a plurality of anonymized data by trial and error. In this case, it is required to prevent re-identification (deterioration in an anonymity level) caused by collation of the plurality of anonymized data regardless of the intention of a worker.

Information on a use condition of use target data (an anonymization method and an importance level of each attribute) is acquired from a data user, a processing data candidate is generated based upon the acquired information, and when a collation result formed of a plurality of any pieces of a processing data candidate group (data obtained by processing a value of each attribute to a lower limit value of a generalized hierarchy definition level and combining the data with each other) satisfies the use condition, a processing data group is provided as a processing data providable group.

### BACKGROUND OF THE INVENTION

### 1. Field of the Invention

The present invention relates to a computer system including a database system for collecting, storing, and analyzing data.

### 2. Description of Related Art

In recent years, business data used in a business system is analyzed, and an effort is made to utilize data using an analysis result of the business data. It is expected that using the analysis result of the business data will lead to resolution of a problem in a current business, and generation of a new service and a new business. Here, the business data used in the business system is often stored and managed in a business database which is one component of the business system.

An effort related to data utilization for the data is also on the increase. In order to promote the data utilization, not only the data is used as it is but also a part of the data is processed, such that an effort also is made to expand its use. For example, with respect to data that cannot clear problems such as a privacy protection issue and legal regulation compliance when the data is used as it is, there is an effort to execute data processing by anonymization and tokenization, and to utilize the data in a form of processing data. However, methods of performing the anonymization and the tokenization are not the same, and trial and error may be required for a content of the processing depending on the purpose of use by a data user. Therefore, it is required to build a data management mechanism that can achieve both data utilization and data anonymization, and tokenization.

In order to achieve both the data utilization and the data anonymization, US-A-2019/266353 discloses a technology in which a plurality of anonymized data candidates are generated and selected. In this technology, anonymization is performed after selecting an anonymization target attribute of target data and anonymization algorithm to generate a plurality of anonymized data, and a privacy metric value and a utility metric value of the anonymized data are calculated, respectively. These metric values can be compared with metric values of other anonymized data candidates, thereby making it possible to provide useful anonymized data.
Patent Literature 1: US-A-2019/266353

### SUMMARY OF THE INVENTION

However, in the technology described in US-A-2019/266353, when the anonymized data is used for the purpose of data analysis, data whose utility metric value of the anonymized data becomes the highest is not always appropriate for the purpose thereof, such that it is required to try a plurality of anonymized data by trial and error. In this case, it is required to prevent re-identification (deterioration in an anonymity level) caused by collation of the plurality of anonymized data regardless of the intention of a worker. However, it is difficult to prevent this re-identification with a prior art and a combination thereof.

Therefore, in order to prevent the re-identification (the deterioration in the anonymity level) caused by the collation of the plurality of anonymized data while a data user tries the plurality of anonymized data for his or her own data analysis purpose, the present invention realizes a data providing server device that provides the data user with a processing data group as a processing data providable group.

A desirable embodiment of the present invention provides a data providing server device that registers data from a data provider, receives a data use application and a data use condition registration request from a data user, registers a data providing condition approved by the data provider, confirms a record satisfying the data providing condition in any combination of processing data generated by anonymizing a use target data, and provides the processing data to the data user, the device comprising: a unit configured to acquire information on a use condition of the use target data from the data user; a unit configured to receive approval with respect to the use condition from the data provider, and to register the approved use condition as the data providing condition; a unit configured to generate the processing data by planning and executing a plurality of processing process method candidates satisfying the data providing condition with respect to target data designated by the data user, based upon data registered in advance by the data provider, generalized hierarchy definition information defined with respect to an attribute value of the data, access authority information set in advance with respect to the data, and the data providing condition; and a unit configured to extract a combination formed of a plurality of any pieces of a generated first processing data group (a second processing data group), to generate collation data by collation thereof, and to register the extracted second processing data group as a processing data providable group when the collation data satisfies the data providing condition.

As another feature of the present invention, the data providing server device further includes a unit configured to extract a third processing data group obtained by deleting some columns or records of the second processing data group when the collation data does not satisfy the data providing condition, to generate collation data by collation thereof, and to register the extracted third processing data group as the processing data providable group when the collation data satisfies the data providing condition.

A desirable embodiment of the present invention provides a data providing method, including: a step of receiving, by a computer system, a data registration request from a data provider and registering data; a step of providing, by the computer system, a registered data list to a data user according to a request from the data user; a step of receiving, by the computer system, a notification of a data use condition for using the data after the data user selects a use target data from the data list; a step of transmitting, by the computer system, an approval request for allowing the data provider to confirm the data use condition of the use target data and to determine whether or not to the use target data, and of receiving, by the computer system, a response from the data provider; a step of receiving, by the computer system, the data processing condition of the use target data transmitted by the data user based upon a use approval content of the use target data; a step of planning, by the computer system, a combination of processing data generation patterns based upon a data processing condition content; a step of executing, by the computer system, a data processing process on the use target data for each combination of the planned processing data generation patterns, and of generating and registering, by the computer system, processing data that achieves a data providing condition in which the data use condition is approved; a step of extracting, by the computer system, a combination formed of a plurality of any pieces of a generated first processing data group (a second processing data group), of generating, by the computer system, collation data by collation thereof, and of registering, by the computer system, the extracted second processing data group as a processing data providable group when the collation data satisfies the data providing condition; a step of providing, by the computer system, the data user with a registered processing data providable group list in response to a processing data list request by the data user; and a step of providing, by the computer system, the data user with target data in the processing data providable group selected by the data user from the processing data providable group list.

When a plurality of anonymized data candidates are presented, only the anonymized data candidates whose privacy risk caused by collation of the anonymized data candidates to be presented is within a permissible range are narrowed down and presented, thereby making it possible to control the privacy risk.

### BRIEF DESCRIPTION OF THE DRAWINGS

FIG. 1 is a system configuration diagram of a computer system to which the present invention is applied;

FIG. 2 is a sequence diagram illustrating a series of process flows related to data registration, data use condition registration, processing data acquisition request, and data acquisition in the present invention;

FIG. 3 is a diagram illustrating a configuration example of a user management table;

FIG. 4 is a diagram illustrating a configuration example of a data use authority management table;

FIG. 5 is a diagram illustrating a configuration example of a data processing request management table;

FIG. 6 is a diagram illustrating a configuration example of a data management table;

FIG. 7 is a diagram illustrating a configuration example of a data processing method management table;

FIGS. 8A, 8B, 8C, 8D, and 8E are diagrams illustrating a configuration example of processing rule definition;

FIG. 9 is a diagram illustrating a configuration example of a data processing method correspondence management table;

FIG. 10 is a diagram illustrating a configuration example of a processing data management table;

FIG. 11 is a diagram illustrating a configuration example of a processing data providable group management table;

FIG. 12 is a schematic diagram illustrating an example of a data registration screen;

FIG. 13 is a schematic diagram illustrating an example of a data list screen;

FIG. 14 is a schematic diagram illustrating an example of a data detail display screen;

FIG. 15 is a schematic diagram illustrating an example of a data use application screen;

FIG. 16 is a schematic diagram illustrating an example of an approval request list screen;

FIG. 17 is a schematic diagram illustrating an example of an approval request detail screen;

FIG. 18 is a schematic diagram illustrating an example of a data processing request screen;

FIG. 19 is a schematic diagram illustrating an example of a processing data list screen;

FIG. 20 is a process flow diagram illustrating a flow of a combination planning process of a processing data generation pattern;

FIG. 21 is a process flow diagram illustrating a flow of a data processing execution process;

FIG. 22 is a process flow diagram illustrating a flow of a first stage process of a collation and confirmation process;

FIG. 23 is a process flow diagram illustrating a flow of a second stage process of the collation and confirmation process;

FIG. 24 is a process flow diagram illustrating a flow of a third stage process of the collation and confirmation process;

FIG. 25 is a diagram illustrating configuration information of original data to be used in a processing data generation example;

FIG. 26 is a diagram illustrating configuration information of a first processing data example;

FIG. 27 is a diagram illustrating configuration information of a second processing data example;

FIG. 28 is a diagram illustrating configuration information of a first reprocessing data example in which processing data is reprocessed for the collation and confirmation;

FIG. 29 is a diagram illustrating configuration information of a second reprocessing data example in which processing data is reprocessed for the collation and confirmation;

FIG. 30 is a diagram illustrating configuration information of a result data example obtained by combining the reprocessing data;

FIG. 31 is a diagram illustrating configuration information of an example of a processing data providable group; and

FIG. 32 is a schematic diagram illustrating an example of a data processing request screen in a second embodiment.

### DESCRIPTION OF EMBODIMENTS

Hereinafter, embodiments for performing the present invention will be described in detail with reference to the drawings.

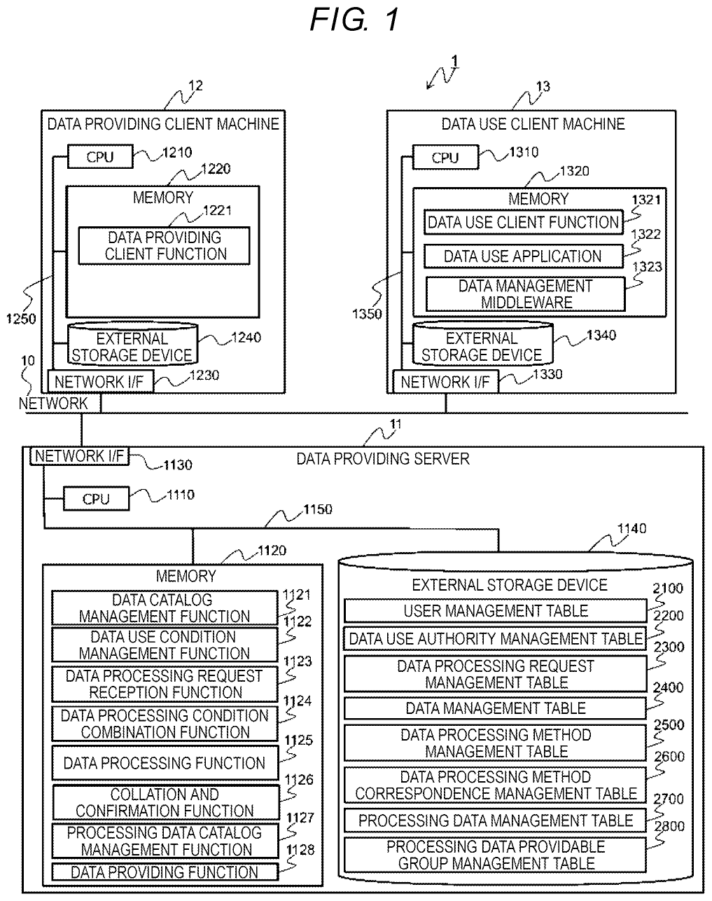

An outline of a computer system 1, which is a first embodiment to which the present invention is applied, will be described with reference to FIG. 1.

The computer system 1 is configured with a data providing server 11, a data providing client machine 12, and a data use client machine 13, all of which are connected to each other so as to be able to perform data communication via a network 10. The server and the client machine may be respectively configured with a plurality of devices. One device may be configured to play a plurality of roles. For example, the data providing server and the data providing client machine may be realized by one device, and the data providing server and the data use client machine may be realized by one device.

The data providing server 11 has a function of accumulating and storing various types of data, processing the corresponding data in response to a request from a user as necessary, and providing the processed data. The data providing server 11, to which a general-purpose server device is mainly applied, includes a CPU 1110, a memory 1120, a network I/F 1130 for controlling data communication with a network, and an external storage device 1140, all of which are connected to each other by a bus 1150. In the memory 1120, a data catalog management function 1121, a data use condition management function 1122, a data processing request reception function 1123, a data processing condition combination function 1124, a data processing function 1125, a collation and confirmation function 1126, a processing data catalog management function 1127, and a data providing function 1128 are realized are by cooperation of a program with the CPU 1110. In the external storage device 1140, a user management table 2100, a data use authority management table 2200, a data processing request management table 2300, a data management table 2400, a data processing method management table 2500, a data processing method correspondence management table 2600, a processing data management table 2700, and a processing data providable group management table 2800 are stored as a database. The description of these management tables will be described later.

The data catalog management function 1121 provides a function of managing information on data registered in the data providing server. Specifically, the data catalog management function 1121 provides a function of presenting a list of registered data, a function of managing specification information of each data (a data provider, a data description, and a data registration date), and a function of providing information for accessing the registered data. The data catalog management function 1121 may be in a form of being integrated with data management functions such as a database management system and a file system for managing actual data, or may be in a form of being independent of those data management functions.

The data use condition management function 1122 provides a function of managing information on a use condition of the data registered in the data providing server. For example, the data use condition management function 1122 can manage a data use condition such as, for example, who is permitted to use the data, where is the data permitted to be used, and for what purpose is the data permitted to be used, or what kind of data processing is permitted to use the data, and to what extent should anonymization be performed to use the data (for example, processing is performed so that a K value by a K anonymization method becomes a predetermined value or more).

When the data registered in the data providing server is used, and when it is required to perform data processing such as masking and anonymization, the data processing request reception function 1123 provides a function of receiving a data processing process request. Here, the data processing request reception function 1123 receives the data processing process request in which target data and a condition for processing process content of the target data is designated. The data processing request reception function 1123 receives not only one processing process at a time but also a request combining various types of processing processes.

The data processing condition combination function 1124 provides a function of planning under what condition the data processing is actually performed, based upon the data processing request received by the data processing request reception function 1123. Here, a combination of selectable data processing methods will be mechanically listed based upon a designated request content.

The data processing function 1125 provides a function of performing the data processing under a designated condition, based upon contents of one or more data processing condition combinations planned by the data processing condition combination function 1124. For example, a masking process and an anonymization process are performed. Here, in order to perform various data processing in response to the requests, a plurality of function groups that respectively provide a different data processing process may be prepared, and the plurality of function groups may be used.

The collation and confirmation function 1126 mechanically lists any combination of the processing data for one or more processing data groups generated by the data processing function 1125, and provides a function of performing collation and confirmation on whether or not a predetermined data providing condition can be satisfied with the information obtained in each combination. Here, when the predetermined data providing condition cannot be satisfied in each combination, it is also possible to confirm whether or not the data providing condition can be satisfied by performing reprocessing such as record deletion and column deletion with respect to a part of the processing data.

The processing data catalog management function 1127 provides a function of managing information on the processing data group generated by the data processing function 1125 and the collation and confirmation function 1126. Specifically, the processing data catalog management function 1127 provides a function of providing a list of the data, a function of managing specification information of each data (information on original data and a data processing content), and a function of providing information for accessing the data. The processing data catalog management function 1127 may be configured to be integrated with data management functions such as a database management system and a file system for managing actual data, may be configured to be independent of those data management functions, and may be configured to be integrated with the data catalog management function 1121.

The data providing function 1128 provides a function of providing the data managed by the data catalog management function 1121 and the processing data catalog management function 1127 based upon the data use condition managed by the data use condition management function 1122.

The data providing client machine 12 is used by a data provider who registers data in the data providing server 11. The data providing client machine 12, to which a general-purpose server device is mainly applied, includes a CPU 1210, a memory 1220, a network I/F 1230 for controlling data communication with the network, and an external storage device 1240, all of which are connected to each other by a bus 1250. In the memory 1220, a data providing client function 1221 is realized by cooperation of a program with the CPU 1210.

The data providing client function 1221 provides a function of registering the data in the data providing server 11 and registering use availability for a data user. The data providing client function 1221 provides these functions in cooperation with the data use condition management function 1122 of the data providing server 11.

The data use client machine 13 is used by a data user who acquires data from the data providing server 11 and uses the data. The data use client machine 13, to which a general-purpose server device is mainly applied, includes a CPU 1310, a memory 1320, a network I/F 1330 for controlling data communication with a network, and an external storage device 1340, all of which are connected to each other by a bus 1350. In the memory 1320, a data use client function 1321, a data use application 1322, and a data management middleware 1323 are realized by cooperation of a program with the CPU 1310.

The data use client function 1321 provides a function of using the data registered in the data providing server 11. Specifically, the data use client function 1321 provides a function of acquiring a list of the registered data, selecting data desired to be used from the list thereof, and registering a use condition. The data use client function 1321 also provides a function of registering a data processing request based upon the use condition. The data use client function 1321 also provides a function of acquiring a list of processing data, selecting data desired to be used from the list thereof, and acquiring the data.

The data use application 1322 provides a function of analyzing the data acquired by using the data use client function 1321. The data use application 1322 may be configured to use a single application or may be configured to use a plurality of applications.

The data management middleware 1323 provides a function of managing the data acquired by using the data use client function 1321 in the data use client machine 13. For example, a database management system and a file system may be used. The data management middleware 1323 may be configured to use a single middleware or may be configured to use a plurality of middleware.

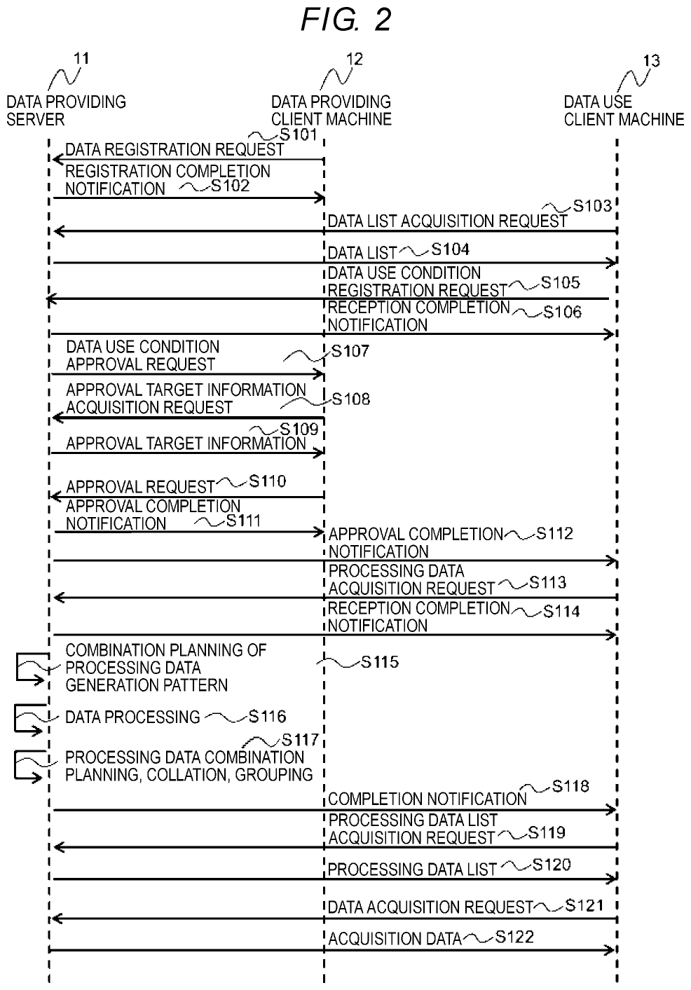

FIG. 2 illustrates a series of process flows related to data registration, data use condition registration, a processing data acquisition request, and data acquisition in the present invention.

First, a data provider uses the data providing client function 1221 of the data providing client machine 12, and performs a data registration request with respect to the data catalog management function 1121 of the data providing server 11 in order to register data to be used in the data providing server 11 (S101). The data catalog management function 1121 receives, stores, and registers the data to be registered, and notifies the data providing client function 1221 of registration completion thereof (S102).

Next, a data user uses the data use client function 1321 of the data use client machine 13, and performs a registered data list acquisition request with respect to the data catalog management function 1121 (S103). The data catalog management function 1121 generates a list of the registered data, and provides a data list to the data use client function 1321 (S104). Next, the data user selects data to be used from the provided data list by using the data use client function 1321, and performs a data use condition registration request for using the data with respect to the data use condition management function 1122 (S105). The data use condition management function 1122 receives a content of the request, and notifies the data use client function 1321 of reception completion thereof (S106).

The data use condition management function 1122 performs a data use condition approval request with respect to the data providing client function 1221 in order to allow the data provider to confirm a use condition of target data and to determine use availability of the target data (S107). The data provider uses the data providing client function 1221, and performs an approval target information acquisition request in order to acquire target data information with respect to the data use condition management function 1122 (S108). The data use condition management function 1122 provides approval target information to the data providing client function 1221 (S109). The data provider confirms the information by using the data providing client function 1221, and performs an approval request with respect to the data use condition management function 1122 when there is no problem (S110). The data use condition management function 1122 registers an approval request content, and notifies the data providing client function 1221 of approval completion thereof (S111). The data use condition management function 1122 notifies the data use client function 1321 of the approval completion based upon the approval result (S112).

Next, when the data user needs a processing process such as data masking and anonymization depending on a use approval content of the target data, the data user performs a processing data acquisition request after designating a data processing condition with respect to the data processing request reception function 1123 (S113). The data processing request reception function 1123 receives a content of the request, and notifies the data use client function 1321 of reception completion thereof (S114).

After receiving the data processing request, the data processing condition combination function 1124 performs combination planning of a pattern of processing data generation based upon a content of the data processing request (S115). After planning, the data processing function 1125 performs data processing based upon a content of the planning (S116). After the data processing, the collation and confirmation function 1126 plans a processing data combination pattern with respect to the processing data group, performs collation for confirming whether or not a predetermined data providing condition can be satisfied even though each data is combined in each combination pattern, group the processing data group, and generates a processing data providable group (S117). After that, the data processing request reception function 1123 notifies the data use client function 1321 of the completion of the data processing process (S118).

After that, the data user uses the data use client function 1321, and performs a registered processing data list acquisition request with respect to the processing data catalog management function 1127(S119).

The processing data catalog management function 1127 generates a list of processing data, and provides the list of processing data to the data use client function 1321 (S120). Next, the data user uses the data use client function 1321, selects the processing data providable group to be used from the provided list of processing data and processing data from the processing data providable group, and performs an acquisition request of the processing data with respect to the data providing function 1128 (S121). The data providing function 1128 provides target data based upon a content of the request (S122).

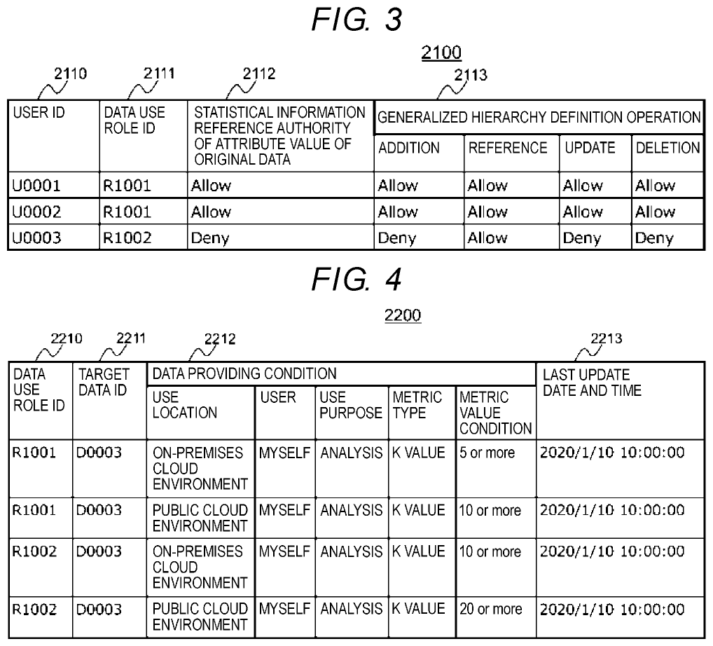

FIG. 3 schematically illustrates configuration information in the user management table 2100 of the database. The user management table 2100 manages information on a data user who uses the data stored in the data providing server 11. The user management table 2100 stores information on a user ID 2110, a data use role ID 2111, statistical information reference authority of an attribute value of original data 2112, and generalized hierarchy definition operation 2113.

The data use role ID 2111 is the same as a data use role ID 2210 managed in the data use authority management table 2200, and can assign a plurality of data use roles to one user and one data use role to a plurality of users. When the user refers to the information of each data registered in the data providing server 11, the statistical information reference authority of the attribute value of the original data 2112 indicates whether or not to permit the user to refer to statistical information of the attribute value in each attribute which is a kind of metadata of the data. The generalized hierarchy definition operation 2113 indicates whether or not permit the user to perform an operation on the information of the generalized hierarchy definition corresponding to each attribute of each data registered in the data providing server 11. The operation includes addition, reference, update, and deletion. A user who is only permitted to refer to the information thereof cannot add, update, and delete the generalized hierarchy definition that is already set, and can only use the definition as it is at the time of performing the data processing request.

FIG. 4 schematically illustrates configuration information in the data use authority management table 2200 of the database. The data use authority management table 2200 manages information on a data use role assigned to a data user. The data use authority management table 2200 stores information on the data use role ID 2210, target data ID 2211, a data providing condition 2212, and a last update date and time 2213.

The target data ID 2211 indicates identification information for identifying data which is a target of the data use role. Here, the target data ID 2211 may use not only the identification information that specifies single data but also the identification information that specifies a plurality of data groups.

The data providing condition 2212 indicates information that designates a use condition with respect to target data. For example, the data providing condition 2212 designates a use location, a user, a use purpose, a metric type, and a metric value condition. Here, the user may designate the user himself or herself to whom the data use role ID is assigned, or may designate a group to which the user belongs. In the metric type and the metric value condition, information indicating a data processing condition when the data is provided may be designated. For example, when the target data is anonymized based upon a K anonymization method, a K value that can be calculated by the K anonymization method may be defined as the metric type, and a threshold value of the K value or a range of a value may be designated as the metric value condition.

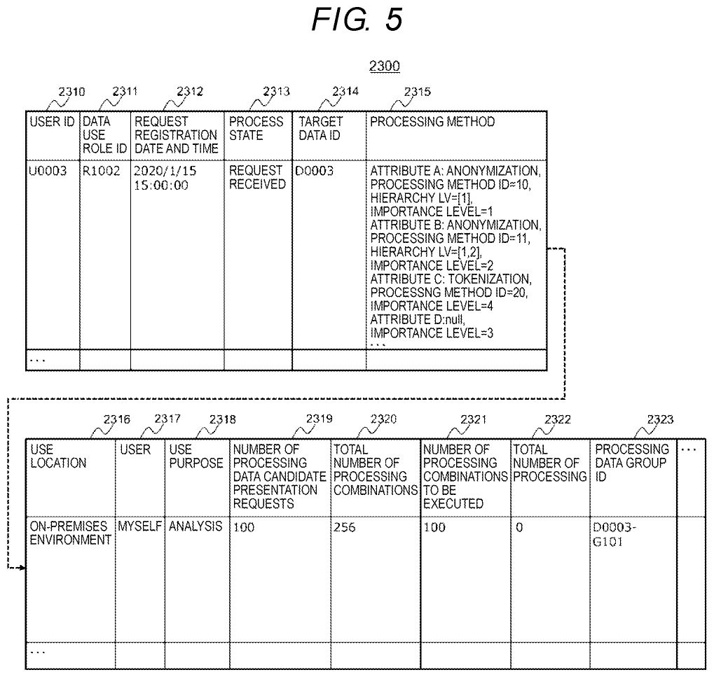

FIG. 5 schematically illustrates configuration information in the data processing request management table 2300 of the database. The data processing request management table 2300 manages information on a data processing request content from a data user. The data processing request management table 2300 stores a user ID 2310, a data use role ID 2311, a request registration date and time 2312, a process state 2313, target data ID 2314, a processing method 2315, a use location 2316, a user 2317, a use purpose 2318, the number of processing data candidate presentation requests 2319, the total number of processing combinations 2320, the number of processing combinations to be executed 2321, the total number of processing 2322, and a processing data group ID 2323.

The user ID 2310 indicates identification information of a data processing requester. The data use role ID 2311 indicates identification information of a data use role assigned to the user at the time of the request. The process state 2313 indicates information indicating a processing state of the request. The target data ID 2314, the processing method 2315, the use location 2316, the user 2317, the use purpose 2318, and the number of processing data candidate presentation requests 2319 indicate information designated by the data user at the time of the request. The processing method 2315 stores information on a processing method type with respect to each attribute of the target data, a processing method ID that identifies the processing method, information on generalized hierarchy identification desired to be applied to the definition when anonymization is performed based upon the generalized hierarchy definition, and an importance level of the attribute. A specific hierarchy may be specified or a plurality of hierarchies may be specified for the information on generalized hierarchy identification. The importance level is an index indicating an importance level of the attribute presented by the data user, and in the data processing process which will be described later, the importance level is used to select a deletion order when a part of the data is deleted as necessary in order to satisfy a data providing condition. The total number of processing combinations 2320 stores a result of calculating a value capable of performing mechanical combination planning from the target data and the content of the processing method. The number of processing combinations to be executed 2321 stores a minimum value of the number of processing data candidate presentation requests 2319 or the total number of processing combinations 2320. The total number of processing 2322 stores the number of processing data generated based upon the data processing request. The processing data group ID 2323 stores information for identifying the generated processing data group.

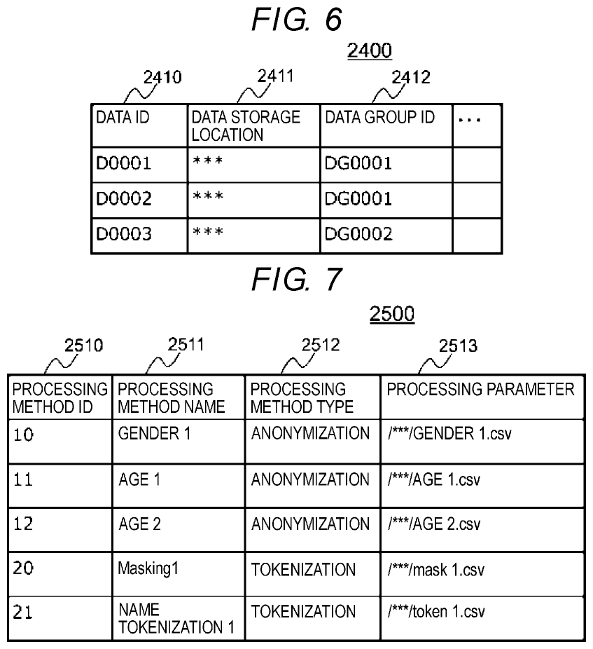

FIG. 6 schematically illustrates configuration information in the data management table 2400 of the database. The data management table 2400 manages information on data managed by the data catalog management function 1121. The data management table 2400 stores information such as a data ID 2410, a data storage location 2411, and a data group ID 2412.

The data ID 2410 indicates identification information of the data. The data storage location 2411 indicates information that identifies a storage location of the data. For example, information in a form of a path name in a file system, a database name and a table name in a database management system, or a URL may be used. The data group ID 2412 indicates identification information of a data group to which the data belongs. One data may belong to a plurality of data groups.

FIG. 7 schematically illustrates configuration information in the data processing method management table 2500 of the database. The data processing method management table 2500 manages information on a data processing method that can be dealt with by the data processing function 1125. The data processing method management table 2500 stores information such as a processing method ID 2510, a processing method name 2511, a processing method type 2512, and a processing parameter 2513.

The processing method ID 2510 indicates identification information of the processing method. The processing method name 2511 indicates an identification name of the processing method. The processing method type 2512 indicates type identification information of the processing method. For example, anonymization, tokenization, and masking may be designated.

Here, the tokenization is a processing method of converting the target data with a predetermined processing method (processing of converting the target data into data that is difficult to be reconverted into original data according to a format and a schema). The masking is a processing method of converting the target data with a predetermined processing method (processing is performed so that the target data cannot be read). The processing parameter 2513 indicates information on processing rule definition used in the data processing process.

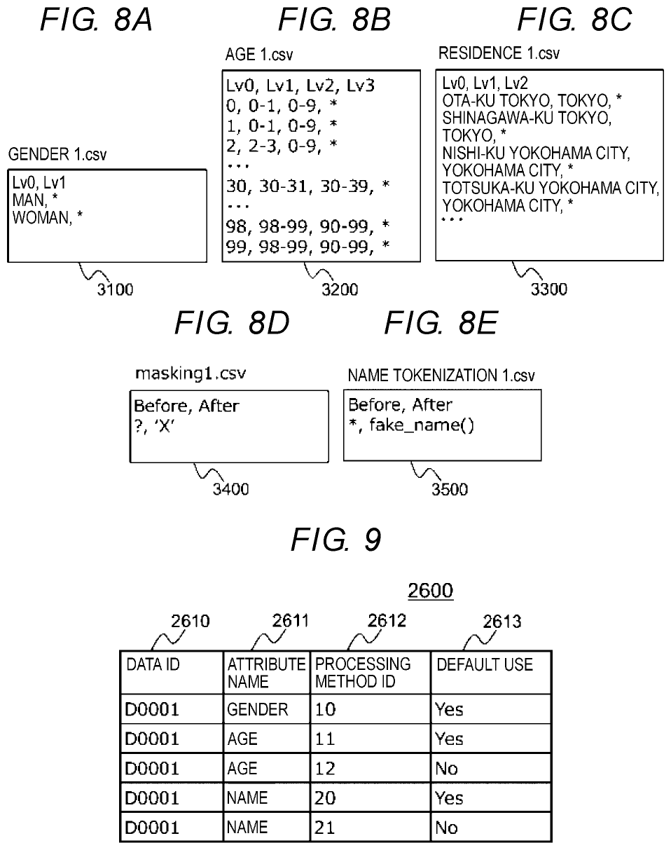

FIGS. 8A, 8B. 8C. 8D, and 8E schematically illustrate configuration information on processing rule definitions 3100, 3200, 3300, 3400, and 3500. The processing rule definition makes it possible to define a content based upon the processing method name 2511 and the processing method type 2512 in the data processing method management table 2500. The content of the processing rule definition makes it possible to identify a storage location by the information of the processing parameter 2513.

First, an example of the processing rule definition 3100 when anonymization is designated as the data processing method type 2512 and a gender 1 is designated as the processing method name 2511 will be described. The processing rule definition 3100 shows an example of handling the generalized hierarchy definition in a csv format with a file name of gender 1.csv. A hierarchy name of the generalized hierarchy definition is defined in a first line of the csv file. A content of the generalized hierarchy definition is defined in a second and subsequent lines of the csv file. In the same manner, the processing rule definitions 3200 and 3300 also show examples of the generalized hierarchy definition.

Next, an example of the processing rule definition 3400 when tokenization is designated as the data processing method type 2512 and masking 1 is designated as the processing method name 2511 will be described. The processing rule definition 3400 shows an example of handling the data processing method in a csv format with a file name of masking1.csv. An identification name that distinguishes before and after processing is defined in a first line of the csv file. A data processing content is defined in a second and subsequent lines of the csv file. Here, a content of replacing any character (a symbol “?” indicating any one character in a regular expression) with a character “X” is shown as an example. Here, the regular expression may be used, a processing script may be written inline, and a processing script including a method name provided by a library to be used may be described. In the same manner, the processing rule definition 3500 shows an example of the data processing process definition.

FIG. 9 schematically illustrates configuration information in the data processing method correspondence management table 2600 of the database. The data processing method correspondence management table 2600 manages information on correspondence between the data processing method defined in the data processing method management table 2500 and the storage data managed by the data catalog management function 1121. The data processing method correspondence management table 2600 stores information such as a data ID 2610, an attribute name 2611, a processing method ID 2612, and a default use 2613.

The data ID 2610 stores the same identification information as that of the data ID 2410 in the data management table 2400. The attribute name 2611 stores each attribute name of target data. The processing method ID 2612 stores the same identification information as that of the processing method ID 2510 in the data processing method management table 2500. As a result, the data processing method can be associated with each attribute of the storage data. A plurality of these associations may be set for one attribute. The default use 2613 indicates information for identifying the processing method to be used by default when a plurality of associations of the processing method are set for the attribute.

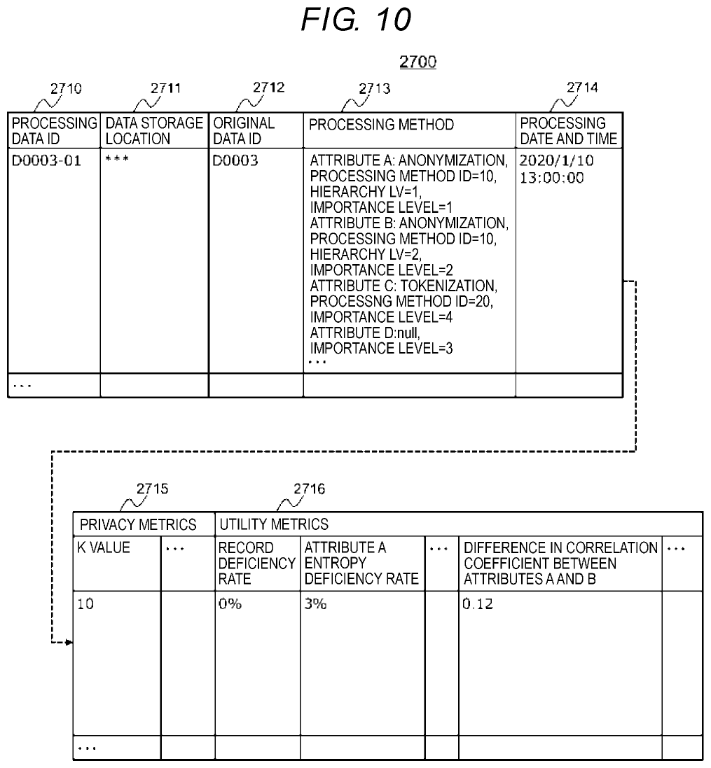

FIG. 10 schematically illustrates configuration information in the processing data management table 2700 of the database. The processing data management table 2700 stores information on the processing data managed by the processing data catalog management function 1127. The processing data management table 2700 stores information such as a processing data ID 2710, a data storage location 2711, an original data ID 2712, a processing method 2713, a processing date and time 2714, privacy metrics 2715, and utility metrics 2716.

The processing data ID 2710 indicates identification information of the processing data. The data storage location 2711 indicates information that identifies a storage location of the processing data. For example, information in a form of a path name in a file system, a database name and a table name in a database management system, or a URL may be used. The original data ID 2712 indicates information for identifying original data of the processing data. The processing method 2713 indicates information for identifying a processing method of the processing data. This information may use the same format as that of the processing method 2315 in the data processing request management table 2300. However, when any processing process is not performed on a certain attribute, a null value may be designated for the processing method type 2512 in order to indicate a state in which any processing process is not performed thereon.

The privacy metrics 2715 indicate information on metrics for determining whether or not the processing data satisfies the data providing condition from a viewpoint of a data provider. For example, when anonymization is performed by the K anonymization method, the K value calculated from the processing data may be indicated.

The utility metrics 2716 indicate information on metrics for examining whether the processing data is useful from a viewpoint of a data user. For example, when some records are deleted to satisfy the data providing condition during the anonymization process, the number of the deleted records and a ratio thereof may be indicated. In any attributes of the original data and the processing data, an entropy deficiency rate may be indicated for each attribute as an index indicating how much an entropy value obtained by quantifying each amount of information changes depending on the anonymization process. In correlation between any attributes of the original data and the processing data, a difference value of a correlation coefficient between the attributes may be indicated for each attribute as an index indicating how much each correlation coefficient value changes due to the anonymization process.

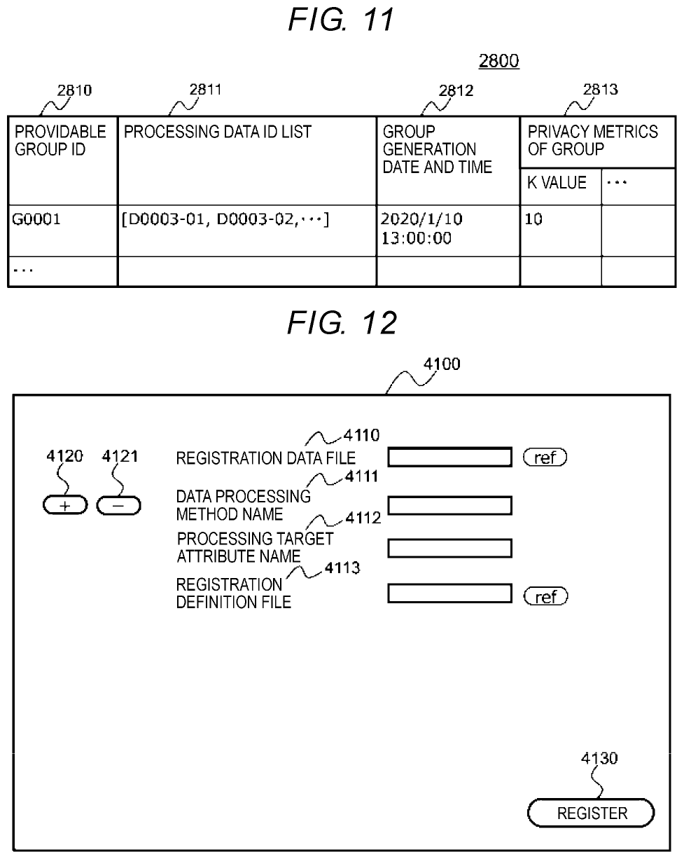

FIG. 11 schematically illustrates configuration information in the processing data providable group management table 2800 of the database. The processing data provable group management table 2800 manages information for handling each combination that satisfies the data providing condition as a processing data providable group, as a result of collating and confirming a combination of any processing data by the collation and confirmation function 1126 with respect to the processing data managed by the processing data catalog management function 1127. The processing data providable group management table 2800 stores information such as a providable group ID 2810, a processing data ID list 2811, a group generation date and time 2812, and group privacy metrics 2813.

The providable group ID 2810 indicates identification information of the processing data providable group. The processing data ID list 2811 indicates a list of processing data IDs belonging to the group.

The group privacy metrics 2813 indicate information on metrics for determining whether or not the data providing condition is satisfied when a processing data group belonging to the group is collated and confirmed, from a viewpoint of a data provider. For example, when anonymization is performed by the K anonymization method, the K value calculated from a collation result of the processing data group may be indicated.

FIG. 12 schematically illustrates a data registration screen 4100 in which the data catalog management function 1121 registers data to be presented to the data provider by using the data providing client function 1221 of the data providing client machine 12. In the embodiment, input and output via a screen will be described as an example, but the present invention is not limited thereto. The same information may be handled from a command, or the same information may be handled as an argument and a parameter of an API for executing the program.

Information on the data provided by the data provider can be inputted on the data registration screen 4100. A processing request for the inputted information can be made to the system by pressing a register button 4130.

A registration data file 4110 makes it possible to input identification information of a registration target data file. For example, a path name of the target data file may be used. A data processing method name 4111 makes it possible to input a name that identifies a data processing method that can be assigned to the data. Here, the same content as the content of the processing method name 2511 of the data processing method management table 2500 may be inputted. A processing target attribute name 4112 makes it possible to input an attribute name existing in the data. Accordingly, it is possible to associate the attribute with the data processing method name 4111. A registration definition file 4113 makes it possible to input identification information of a definition file associated with the data processing method name 4111. For example, a path name of a target definition file may be used. Accordingly, it is possible to associate the content of the registration definition file with the data processing method name 4111. Here, the same contents as those of the processing rule definitions 3100, 3200, 3300, 3400, and 3500 may be inputted.

With respect to a series of setting items including the data processing method name 4111, the processing target attribute name 4112, and the registration definition file 4113, a plurality of setting items can be inputted by pressing a + button 4120, and any setting item can be deleted by pressing a − button 4121.

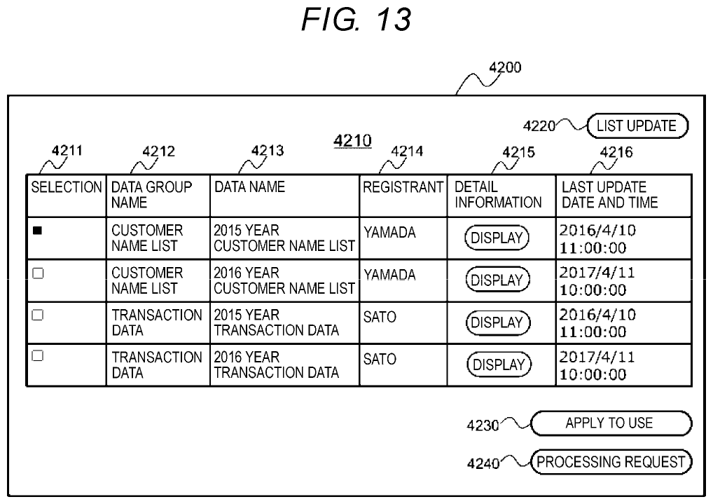

FIG. 13 schematically illustrates a data list screen 4220 in which the data catalog management function 1121 refers to a list of registration data to be presented to the data provider or the data user by using the data providing client function 1221 of the data providing client machine 12 or the data use client function 1321 of the data use client machine 13. A data list screen 4200 enables the data provider and the data user to refer to a data list and to refer to detailed information of each data. The data list screen 4200 further enables the data user to perform a use application by a data use condition registration request, and to perform a processing request by a processing data acquisition request.

The data list screen 4200 outputs a data list table 4210. The data list table 4210 includes output fields for selection 4211, a data group name 4212, a data name 4213, a registrant 4214, detailed information 4215, and last update date and time 4216. The selection 4211 is used to select a target when performing the use application and the processing request which will be described later. The data group name 4212 and the data name 4213 output identification information of each target data. The registrant 4214 outputs identification information of a user who registers the target data in the data providing server 11. The detailed information 4215 can refer to detailed data of the data by pressing a display button in the field. A content of the data list table 4210 can be updated by pressing a list update button 4220. By pressing an apply to use button 4230 after selecting any data in the selection 4211, the use condition registration of the data can be performed. By pressing a processing request button 4240 after selecting any data in the selection 4211, the processing request of the data can be performed.

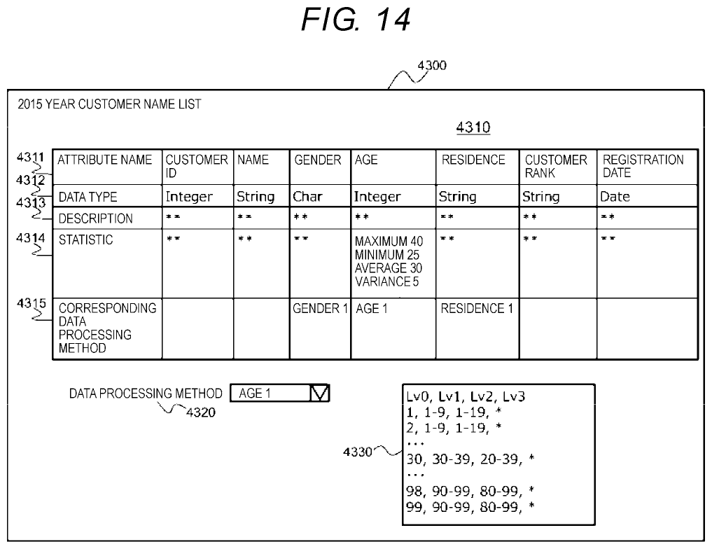

FIG. 14 schematically illustrates a data detail display screen 4300 in which the data catalog management function 1121 refers to details of registration data to be presented to a data provider or a data user by using the data providing client function 1221 of the data providing client machine 12 or the data use client function 1321 of the data use client machine 13. The data detail display screen 4300 enables the data provider and the data user to refer to detailed data information.

The data detail display screen 4300 is displayed by pressing the display button in the field of the detailed information 4215 of the data list screen 4200. The data detail display screen 4300 outputs a data detail table 4310. The data detail table 4310 includes output fields for an attribute name 4311, a data type 4312, a description 4313, a statistic 4314, and a corresponding data processing method 4315. Corresponding information of target data is outputted to each field. The description 4313 may handle information for identifying whether the attribute is an identifier, a quasi-identifier, or other attributes. By using this information, a type of the attribute can be specified in the data processing process. The statistic 4314 can output information such as a statistic of a value in the attribute of the target data (maximum, minimum, average, and variance) and appearance frequency of each value. By referring to this information, it is possible to grasp tendency of data in the attribute of the target data. The statistic 4314 can also limit the output based upon the setting information in the statistical information reference authority 2112 of the attribute value of the original data in the user management table 2100. The corresponding data processing method 4315 outputs a list of identification information of the data processing method assigned to the attribute of the target data. For example, the corresponding data processing method 4315 may output the processing method name 2511 of the data processing method management table 2500. Summarizing the contents outputted to the corresponding data processing method 4315 can be selected in a field of a data processing method 4320 of the data detail display screen 4300. When any data processing method is selected here, a content of the selected data processing method can be outputted to a data processing method output field 4330 on the screen. The outputted content in this field may be the same as those of the processing rule definitions 3100, 3200, 3300, 3400, and 3500. By referring to the outputted content in this field, a user can select a desirable data processing method.

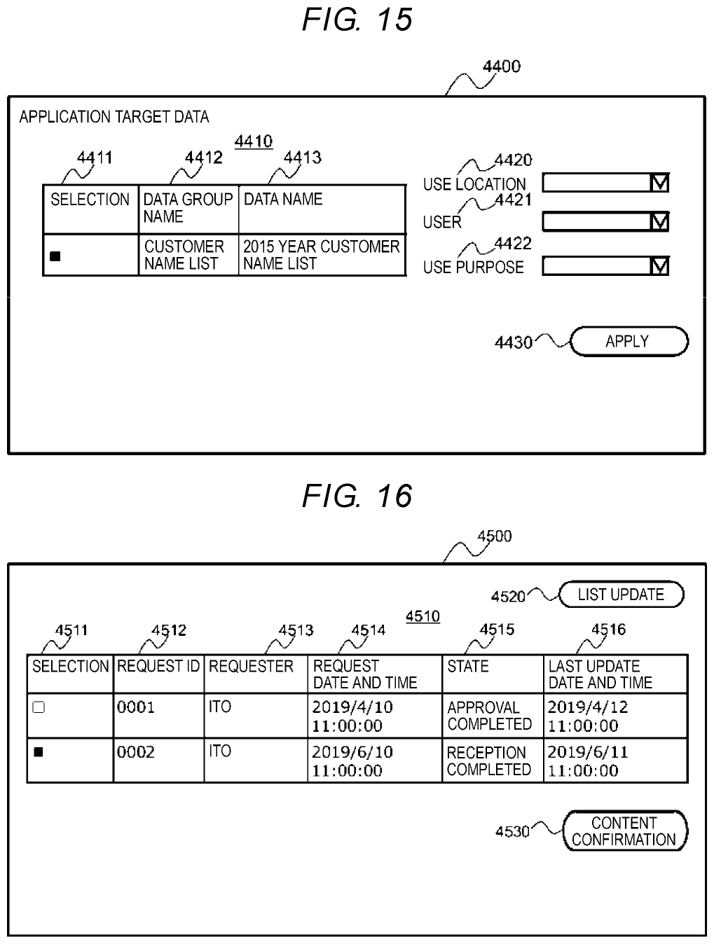

FIG. 15 schematically illustrates a data use application screen 4400 in which the data use condition management function 1122 inputs a data use condition registration request content to be presented to a data user by using the data use client function 1321 of the data use client machine 13. The data use application screen 4400 enables the data user to perform a data use application.

The data use application screen 4400 is displayed by pressing the apply to use button 4230 on the data list screen 4200. The data use application screen 4400 outputs an application target data table 4410. The application target data table 4410 includes output fields for a selection 4411, a data group name 4412, and a data name 4413. The information of the data selected by the data list screen 4200 is outputted as it is in the output fields for the selection 4411, the data group name 4412, and the data name 4413. The data use application screen 4400 includes input fields related to a use location 4420, a user 4421, and a use purpose 4422 as various input information in the data use application. The user performs selection or input in each input field according to a use form. After the input of each input field, the data use application can be registered by pressing an apply button 4430. An inputted content is registered in the data providing condition 2212 of the data use authority management table 2200.

FIG. 16 schematically illustrates an approval request list screen 4500 in which the data use condition management function 1122 refers to a list of a data use condition being requested for approval to be presented to a data provider by using the data providing client function 1221 of the data providing client machine 12. The approval request list screen 4500 enables the data provider to refer to the list being requested for approval regarding the data use condition.

The approval request list screen 4500 outputs an approval request list table 4510. The approval request list table 4510 includes output fields for a selection 4511, a request ID 4512, a requester 4513, a request date and time 4514, a state 4515, and a last update data and time 4516. The selection 4511 is used to select a target for detailed confirmation and for determining approval propriety, which will be described later. The request ID 4512 outputs identification information given when the request is registered in the data use condition management function 1122. The state 4515 outputs a processing state related to the request. For example, the reception may be completed after the request is received and registered, and the approval may be completed after approval by the data provider is completed. A content of the approval request list table 4510 can be updated by pressing a list update button 4520. By selecting any request content record in the selection 4511 and then pressing a content confirmation button 4530, content confirmation of the request content record can be performed.

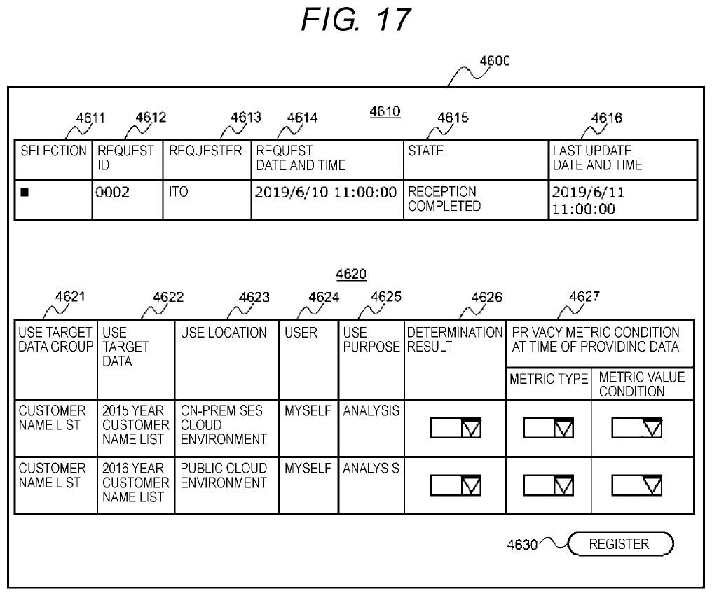

FIG. 17 schematically illustrates an approval request detail screen 4600 in which the data use condition management function 1122 refers to the details of a data use condition being requested for approval to be presented to a data provider by using the data providing client function 1221 of the data providing client machine 12. The approval request detail screen 4600 enables the data provider to refer to details of the content being requested for approval regarding the data use condition, to register approval propriety, and to set a privacy metric condition to be satisfied when data is used based upon the data use condition.

The approval request detail screen 4600 outputs a request record table 4610 and a request detail content table 4620. The request record table 4610 includes output fields for a selection 4611, a request ID 4612, a requester 4613, a request date and time 4614, a state 4615, and a last update date and time 4616 as a content of the request content record. These pieces of information have the same contents at those of the approval request list table 4510. The request detail content table 4620 outputs a use target data group 4621, a use target data 4622, a use location 4623, a user 4624, a use purpose 4625, a determination result 4626, and a privacy metric condition 4627 at the time of providing data. The use target data group 4621, the use target data 4622, the use location 4623, the user 4624, and the use purpose 4625 thereamong output the contents inputted on the data use application screen 4400. The data provider confirms these pieces of information and determines whether or not the data can be used according to the use condition. A determination result is inputted in the determination result 4626. When it is determined that the data can be used, the privacy metric condition 4627 at the time of providing data is inputted as necessary. For example, when it is determined that the target data can be provided by anonymizing the target data up to a predetermined level by the K anonymization method, by using a K value to be satisfied with processing data obtained by processing the data, it is set as a privacy metric condition that the K value is equal to or greater than a threshold value indicating the predetermined level. Here, the K value is selected as the metric type, and it is set that the effect that the K value is equal to or greater than a predetermined threshold value can be selected under the metric value condition. After inputting the determination result 4626 and the privacy metric condition 4627 at the time of providing data, an approval propriety result with respect to the request content record can be registered by pressing a register button 4630.

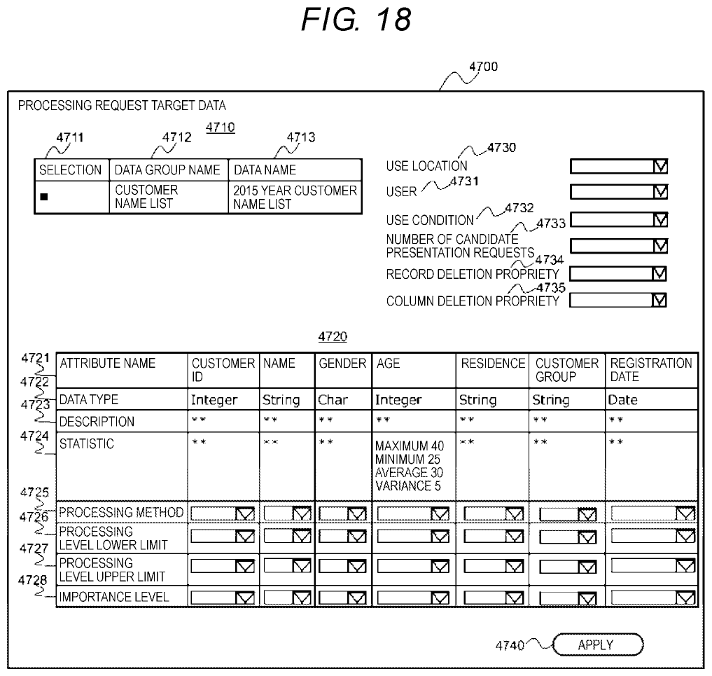

FIG. 18 schematically illustrates a data processing request screen 4700 in which the data processing request reception function 1123 requests processing of target data to be presented to a data user by using the data use client function 1321 of the data use client machine 13. The data processing request screen 4700 enables the data user to perform a data processing request.

The data processing request screen 4700 is displayed by pressing the processing request button 4240 on the data list screen 4200. The data processing request screen 4700 outputs a processing request target data table 4710 and a processing request content table 4720. The processing request target data table 4710 includes output fields for a selection 4711, a data group name 4712, and a data name 4713. The information of the data selected by the data list screen 4200 is outputted as it is in the output fields for the selection 4711, the data group name 4712, and the data name 4713. The processing request table 4720 includes fields for an attribute name 4721, a data type 4722, a description 4723, a statistic 4724, a processing method 4725, a processing level lower limit 4726, a processing level upper limit 4727, and an importance level 4728.

The attribute name 4721, the data type 4722, the description 4723 and the statistic 4724 may be the same as the outputted content of the data detail display screen 4300. The data user fills in the fields of the processing method 4725, the processing level lower limit 4726, the processing level upper limit 4727, and the importance level 4728. The processing method 4725 is selected from the corresponding data processing method 4315 on the data detail display screen 4300. When the processing method corresponds to anonymization, the processing level lower limit 4726 and the processing level upper limit 4727 designate an upper limit and a lower limit of a value for performing the data processing request in a level of the generalized hierarchy definition for the anonymization process. The importance level 4728 inputs information that supports an importance level of each attribute of the data. For example, a value indicating the relative importance of each attribute may be inputted. Based upon the value of this importance value, display order when displaying a list of processing data candidates can be changed. After a processing data group is generated based upon the data processing request content, when the processing data group can not satisfy a predetermined data providing condition, and can satisfy the data providing condition by deleting any column, a column to be deleted can be preferentially selected based upon the priority.

The data processing request screen 4700 includes input fields for a use location 4730, a user 4731, a use condition 4732, the number of candidate presentation requests 4733, record deletion propriety 4734, and column deletion propriety 4735 as various input information in the data processing request. The user performs selection or input in each input field according to a use form. After the input of each input field, the data processing request can be registered by pressing an apply button 4740. An inputted content is registered in the data processing request management table 2300.

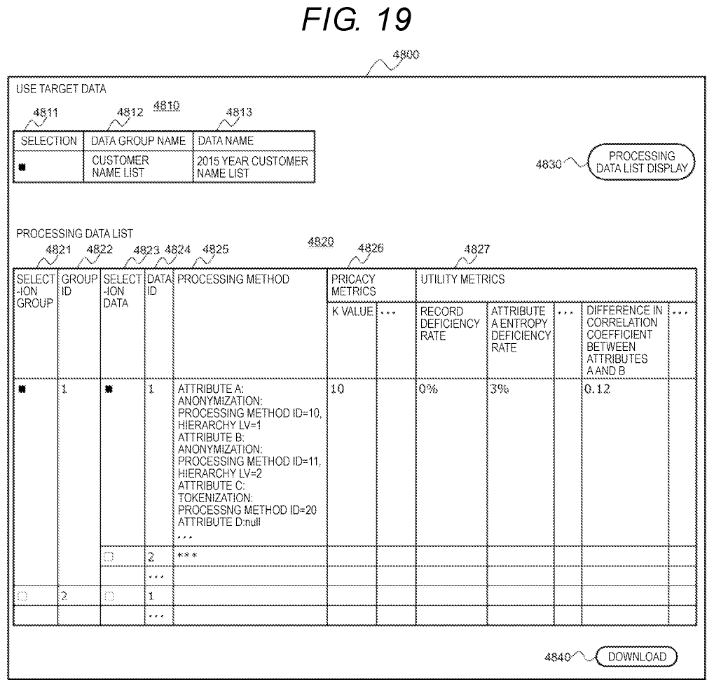

FIG. 19 schematically illustrates a processing data list screen 4800 in which the processing data catalog management function 1127 refers to a list of target processing data to be presented to a data user by using the data use client function 1321 of the data use client machine 13. The processing data list screen 4800 enables the data user to refer to the processing data list and to acquire the selected processing data.

The processing data list screen 4800 outputs a use target data table 4810 and a processing data list table 4820. The use target data table 4810 includes output fields for a selection 4811, a data group name 4812, and a data name 4813. The information of the record in which the data processing process is completed among the records of the processing request target data table 4710 of the data processing request screen 4700 is outputted as it is in the output fields for the selection 4811, the data group name 4812, and the data name 4813. The user can refer to a content of the processing data list table 4820 by selecting any record with the selection 4811 and pressing a processing data list display button 4830. The processing data list table 4820 includes output fields for a selection group 4821, a group ID 4822, selection data 4823, a data ID 4824, a processing method 4825, privacy metrics 4826, and utility metrics 4827. The group ID 4822 outputs the identification information of the processing data providable group generated by the collation and confirmation function 1126 after the data processing process by the data processing function 1125. Here, the providable group ID 2810 in the processing data providable group management table 2800 may be used. The data ID 4824 outputs identification information of the processing data in the processing data group of the processing data providable group. Here, the processing data ID of the processing data ID list 2811 in the processing data providable group management table 2800 may be used. The processing method 4825, the privacy metrics 4826, and the utility metrics 4827 output such information regarding the processing data. Here, contents of the processing method 2713, the privacy metrics 2715, and the utility metrics 2716 in the processing data management table 2700 may be used. The user selects one group after referring to various output information of the processing data list table 4820, and enables a field of the corresponding selection group 4821. Any data is selected from the group and a field of the corresponding selection data 4823 is enabled. After that, by pressing a download button 4840, the target processing data can be acquired. Here, since the group corresponds to the processing data providable group and there is a possibility that the group cannot satisfy the data providing condition, data acquisition across the group is suppressed.

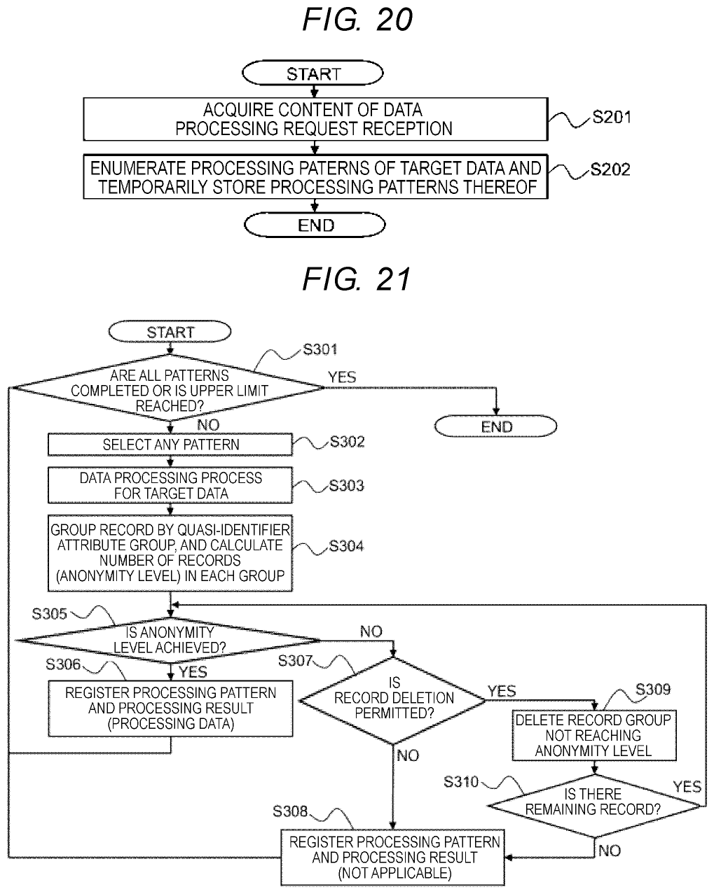

FIG. 20 illustrates a flow of a combination planning process of a processing data generation pattern. This process corresponds to S115 in FIG. 2.

First, in S201, the data processing condition combination function 1124 acquires a content of data processing request reception. The content thereof is obtained from the data processing request management table 2300. Next, in S202, the data processing condition combination function 1124 enumerates processing patterns of target data, temporarily stores the processing patterns thereof, and ends this process flow. Here, based upon the information of the processing method 2315 of the data processing request management table 2300, variations of the processing method are enumerated for each attribute, and combinations thereof are mechanically enumerated.

FIG. 21 illustrates a flow of a data processing execution process. This process corresponds to S116 in FIG. 2.

First, in S301, the data processing function 1125 confirms whether or not a process, which will be described later, is executed for all the processing patterns temporarily stored in S202, and also confirms whether or not the number of executions of the process, which will be described later, reaches the number of processing data candidate presentation requests 2319 of the data processing request management table 2300. When the execution of the process is completed for all the processing patterns or the number of executions thereof reaches the number of processing data candidate presentation requests, this process flow is completed, and when the execution of the process is not completed therefor, the process proceeds to S302.

In S302, the data processing function 1125 selects any one from the processing patterns. Next, in S303, the data processing function 1125 performs a data processing process on target data. Next, in S304, the data processing function 1125 groups records by a quasi-identifier attribute group of the processing data, and calculates the number of records in each group. The calculated number of records corresponds to the K value in the K anonymization method. In order to identify the quasi-identifier attribute group, the information in a field of the description 4313 of the data detail display screen 4300 is used. Next, in S305, the data processing function 1125 confirms whether or not an anonymity level designated by the data providing condition can be achieved based on the calculated value. When the anonymity level is achieved, the process proceeds to S306, and when the anonymity level is not achieved, the process proceeds to S307.

In S306, the data processing function 1125 registers the processing pattern and the processing data in the processing data management table 2700, and the process proceeds to S301.

In S307, the data processing function 1125 confirms whether or not record deletion is permitted in the data processing process. Here, the information designated by the record deletion propriety 4734 of the data processing request screen 4700 is used. When the record deletion is not permitted, the process proceeds to S308, and when the record deletion is permitted, the process proceeds to S309.

In S308, the data processing function 1125 registers a fact that there is no processing data that matches the data providing condition in the processing pattern in the processing data management table 2700, and the process proceeds to S301. Here, when there is no processing that matches the condition, the number of processing data corresponding to the processing pattern may be registered as 0 in the processing data management table 2700, and the processing pattern may not be registered in the processing data management table 2700.

In S309, the data processing function 1125 deletes a record group in which the number of records of each group calculated in S304 does not reach an anonymity level under a predetermined data providing condition. After that, in S310, the data processing function 1125 checks whether or not there is a remaining record in the target processing data. When there is the remaining record therein, the process proceeds to S305, and when there is no remaining record therein, the process proceeds to S308.

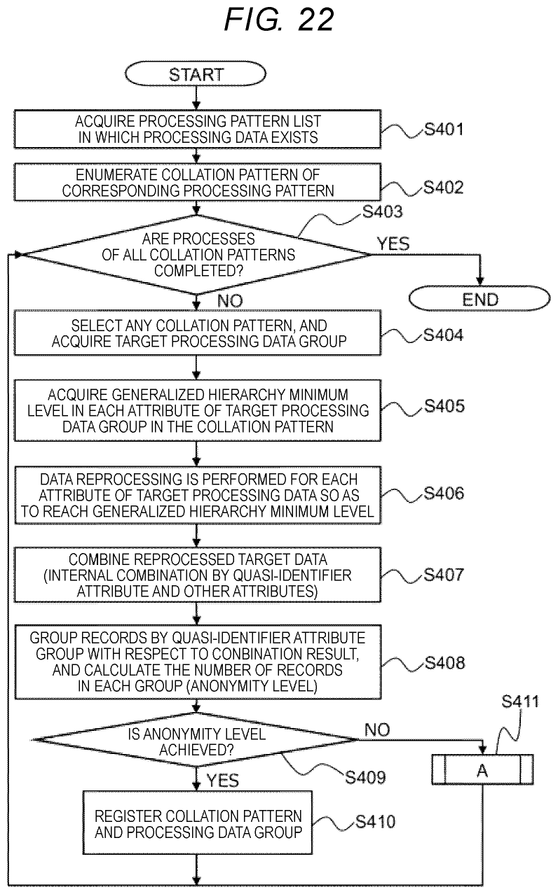

FIGS. 22, 23, and 24 illustrate a series of flows of a collation and confirmation process. This process corresponds to S117 in FIG. 2. FIG. 22 illustrates a flow of a first stage process of the collation and confirmation process.

First, in S401, the collation and confirmation function 1126 acquires a list of processing patterns in which the processing data exists. Here, the information registered in the processing data management table 2700 by S306 and S308 is used. Next, in S402, the collation and confirmation function 1126 enumerates a collation pattern of the processing patterns. Here, any number of processing patterns are selected, such as any one pattern selected from the processing patterns, a combination of any two selected patterns, and a combination of any three selected patterns, and the selected processing patterns are mechanically combined to enumerate the collation patterns. Next, in S403, the collation and confirmation function 1126 confirms whether or not a process, which will be described later, is executed for all the collation patterns. When the execution of the process is completed for all the collation patterns, this process flow is completed, and when the execution of the process is not completed therefor, the process proceeds to S404.

In S404, the collation and confirmation function 1126 selects any one collation pattern and acquires a target processing data group. In S405, the collation and confirmation function 1126 acquires a generalized hierarchy minimum level in each attribute of the target processing data group in the collation pattern. For example, when processing data A and processing data B are target data, both the processing data A and the processing data B have an attribute referred to as an attribute P, LV0 (raw data), LV1, LV2, and LV3 (all data are aggregated into one group as *) are defined as generalized hierarchy definitions in the attribute P, the attribute P of the processing data A is processed with LV1, and the attribute P of the processing data B is processed with LV2, the generalized hierarchy minimum level of the attribute P becomes LV1.

In S406, the collation and confirmation function 1126 performs reprocessing of the data for each attribute of the target processing data so as to reach the generalized hierarchy minimum level. For example, when the attribute P in the above example is age, LV1 is two-year increments such as 10 and 11 years old, and LV2 is four-year increments such as 10 to 13 years old, and when there is a record in which a value of the attribute P is 10 to 13 years old in the processing data B, the record is reprocessed into 2 records. A value of 10 and 11 years old is set for the attribute P of one record, and a value of 12 and 13 years old is set for the attribute P of the other record. In this manner, the value of the attribute is divided until the generalized hierarchy minimum level is reached, and the number of records is increased according to the division.

Next, in S407, the collation and confirmation function 1126 combines the reprocessed target data. Specifically, internal combination is performed under an AND condition of a quasi-identifier attribute and other attributes of the reprocessed target data. In order to confirm whether the attribute is the quasi-identifier attribute or other attributes, the information registered in the field of the description 4313 of the data detail display screen 4300 related to the original data of the data is used.

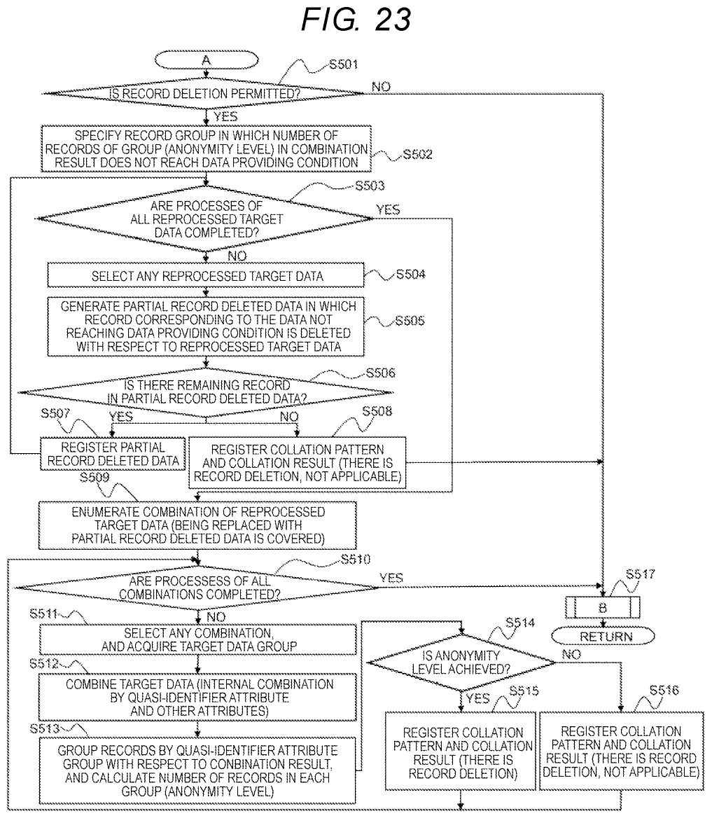

Next, in S408, the collation and confirmation function 1126 groups the records by the quasi-identifier attribute group with respect to a combination result, and calculates the number of records in each group, that is, the anonymity level (the K value in the K anonymization method). Next, in S409, the collation and confirmation function 1126 confirms whether or not the anonymity level designated by the data providing condition can be achieved based upon the calculated value. When the anonymity level is achieved, the process proceeds to S410, and when the anonymity level is not achieved, the process proceeds to S411 (S501 in FIG. 23, which will be described later).

In S410, the collation and confirmation function 1126 registers the collation pattern and the processing data group in the processing data management table 2700, and registers correspondence information of the collation pattern and the processing data group in the processing data providable group management table 2800. After that, the process proceeds to S403.

Next, FIG. 23 illustrates a flow of a second stage process (S411) of the collation and confirmation process. This process is executed as a subsequent process of S409 in FIG. 22 described above.

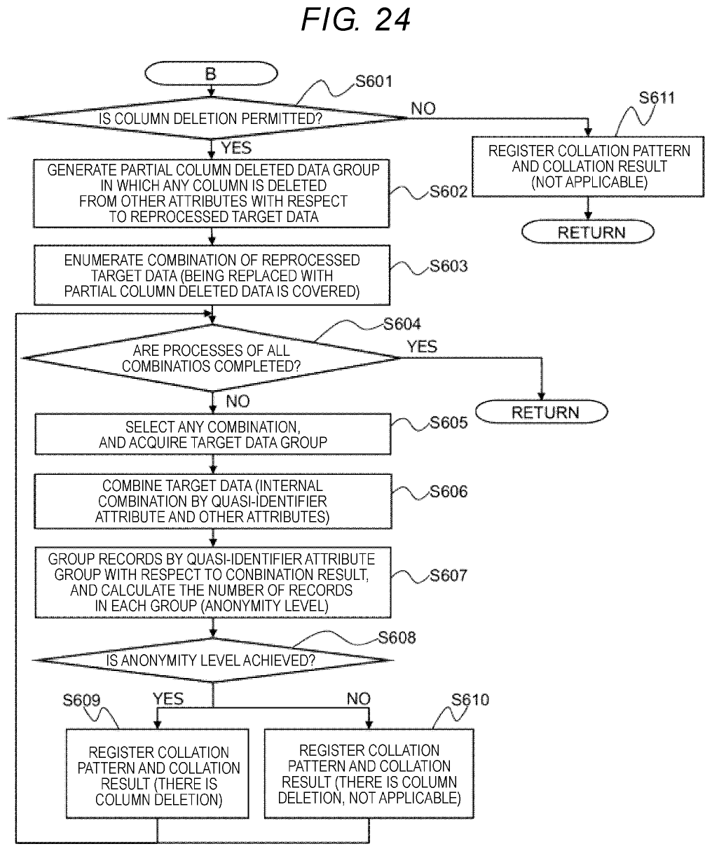

First, in S501, the collation and confirmation function 1126 confirms whether or not record deletion is permitted in the process request. Here, the information designated by the record deletion propriety 4734 of the data processing request screen 4700 is used. When the record deletion is not permitted, the process proceeds to S517 (S601 in FIG. 24, which will be described later), and when the record deletion is permitted, the process proceeds to S502.

In S502, the collation and confirmation function 1126 specifies a record group in which the number of records of each group in the combination result does not reach a predetermined data providing condition. That is, the collation and confirmation function 1126 specifies the record group in which the anonymity level (the K value of the K anonymization method) of each group in the combination result does not reach the data providing condition. In S503, the collation and confirmation function 1126 confirms whether or not a process, which will be described later, is executed for all the reprocessed target data. When the execution of the process is completed for all the reprocessed target data, the process proceeds to S509, and when the execution thereof is not completed therefor, the process proceeds to S504.

In S504, the collation and confirmation function 1126 selects any one reprocessed target data. In S505, the collation and confirmation function 1126 generates partial record deleted data in which a record group that does not reach the data providing condition is deleted, with respect to the reprocessed target data. In S506, the collation and confirmation function 1126 checks whether or not there is a remaining record in the partial target record deleted data. When there is the remaining record therein, the process proceeds to S507, and when there is no remaining record therein, the process proceeds to S508.

In S507, the collation and confirmation function 1126 registers the processing pattern and the processing data group in the processing data management table 2700, and registers the correspondence information of the collation pattern and the processing data group in the processing data providable group management table 2800. After that, the process proceeds to S503.

In S508, the collation and confirmation function 1126 registers the fact that there is no processing data that matches the data providing condition in the processing pattern in the processing data management table 2700, and registers a fact that there are no processing data corresponding to the collation pattern and the partial record deleted data in the processing data providable group management table 2800. After that, the process proceeds to S517 (S601 in FIG. 24, which will be described later).

In S509, the collation and confirmation function 1126 enumerates the combination of the reprocessed target data. Here, a combination in which a part or all of the reprocessed target data is replaced with the partial record deleted data is also covered.

In S510, the collation and confirmation function 1126 confirms whether or not a process, which will be described later, is executed for all the combinations. When the execution of the process is completed for all the combinations, the process proceeds to S517 (S601 in FIG. 24, which will be described later), and when the execution of the process is not completed therefor, the process proceeds to S511.

In S511, the collation and confirmation function 1126 selects any one combination and acquires a target data group. In S512, the collation and confirmation function 1126 combines the target data group. Specifically, internal combination is performed under an AND condition of a quasi-identifier attribute and other attributes of the target data group. In order to confirm whether the attribute is the quasi-identifier attribute or other attributes, the information registered in the field of the description 4313 of the data detail display screen 4300 related to the original data of the data is used.

Next, in S513, the collation and confirmation function 1126 groups the records by the quasi-identifier attribute group with respect to a combination result, and calculates the number of records in each group, that is, the anonymity level (the K value in the K anonymization method). Next, in S514, the collation and confirmation function 1126 confirms whether or not the anonymity level designated by the data providing condition can be achieved based upon the calculated value. When the anonymity level is achieved, the process proceeds to S515, and when the anonymity level is not achieved, the process proceeds to S516.

In S515, the collation and confirmation function 1126 registers the collation pattern and the processing data group in the processing data management table 2700, and registers the correspondence information of the collation pattern and the processing data group in the processing data providable group management table 2800. After that, the process proceeds to S510.

In S516, the collation and confirmation function 1126 registers the fact that there is no processing data that matches the data providing condition in the processing pattern in the processing data management table 2700, and registers the fact that there are no processing data corresponding to the collation pattern and the partial record deleted data in the processing data providable group management table 2800. After that, the process proceeds to S510.

Next, FIG. 24 illustrates a flow of a third stage process of the collation and confirmation process (S517). This process is executed as a subsequent process of S501, S508, and S510 of FIG. 23 described above.

First, in S601, the collation and confirmation function 1126 confirms whether or not column deletion is permitted in this processing request. Here, the information designated by the column deletion propriety 4735 of the data processing request screen 4700 is used. When the column deletion is not permitted, the process proceeds to S611, and when the column deletion is permitted, the process proceeds to S602.

In S602, the collation and confirmation function 1126 generates partial column deleted data in which any column is deleted from other attributes, with respect to the reprocessed target data. Here, all combinations, such as data obtained by deleting any column from the target column, data obtained by deleting any two columns, and data obtained by deleting any three columns, are covered. In order to select a column which becomes a deletion candidate, the information on the importance level for each column registered in the processing method 2315 in the data processing request management table 2300 may be used.

In S603, the collation and confirmation function 1126 enumerates the combination of reprocessed target data. Here, a combination in which a part or all of the reprocessed target data is replaced with the partial column deleted data is also covered.

In S604, the collation and confirmation function 1126 confirms whether or not a process, which will be described later, is executed for all the combinations. When the execution of the process is completed for all the combinations, this process flow is completed, and when the execution of the process is not completed therefor, the process proceeds to S605.

In S605, the collation and confirmation function 1126 selects any one combination and acquires a target data group. In S606, the collation and confirmation function 1126 combines the target data group. Specifically, internal combination is performed under an AND condition of a quasi-identifier attribute and other attributes of the target data group. In order to confirm whether the attribute is the quasi-identifier attribute or other attributes, the information registered in the field of the description 4313 of the data detail display screen 4300 related to the original data of the data is used.

Next, in S607, the collation and confirmation function 1126 groups the records by the quasi-identifier attribute group with respect to a combination result, and calculates the number of records in each group, that is, the anonymity level (the K value in the K anonymization method). Next, in S608, the collation and confirmation function 1126 confirms whether or not the anonymity level designated by the data providing condition can be achieved based upon the calculated value. When the anonymity level is achieved, the process proceeds to S606, and when the anonymity level is not achieved, the process proceeds to S610.

In S609, the collation and confirmation function 1126 registers the processing pattern and the processing data group in the processing data management table 2700, and registers the correspondence information of the collation pattern and the processing data group in the processing data providable group management table 2800. After that, the process proceeds to S604.

In S610, the collation and confirmation function 1126 registers the fact that there is no processing data that matches the data providing condition in the processing pattern in the processing data management table 2700, and registers a fact that there are no processing data corresponding to the collation pattern and the partial column deleted data in the processing data providable group management table 2800. After that, the process proceeds to S604.

In S611, the collation and confirmation function 1126 registers the fact that there is no processing data that matches the data providing condition in the processing pattern in the processing data management table 2700, and registers a fact that there is no processing data corresponding to the collation pattern in the processing data providable group management table 2800. After that, this process flow is completed.

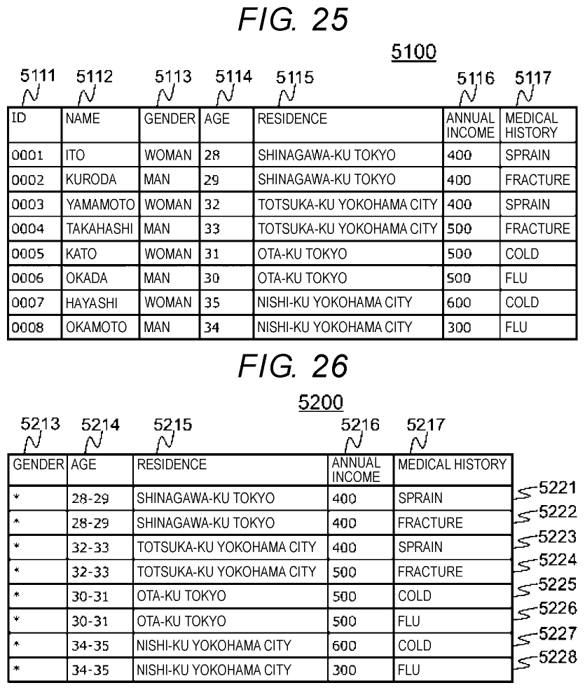

FIGS. 25 to 31 illustrates an example related to the generation of the processing data and the generation of the processing data providable group using the processing flow described so far. In this example, an example of performing the anonymization by the K anonymization method is shown, and the data providing condition assumes a case in which the K value is 2 or more.

FIG. 25 illustrates configuration information of original data 5100 used in a processing data generation example. The original data 5100 is table-type data, and is configured with attributes such as an ID 5111, a name 5112, a gender 5113, an age 5114, a residence 5115, an annual income 5116, and a medical history 5117. Here, the ID 5111 and the name 5112 are attributes corresponding to the identifiers. The gender 5113, the age 5114, and the residence 5115 are attributes corresponding to the quasi-identifiers. The annual income 5116 and the medical history 5117 are attributes corresponding to other attributes.

FIG. 26 illustrates configuration information of processing data 5200 generated by processing the original data 5100. The processing data 5200 shows an example in which the anonymization process is performed on the original data 5100 based upon the generalized hierarchy definition. First, the ID 5111 and the name 5112 of the original data 5100 are deleted. Next, the gender 5113, the age 5114, and the residence 5115 of the original data 5100 are processed by using the processing rule definitions 3100, 3200, and 3300, respectively. This example shows a result in which LV1 is applied to the gender 5113, LV1 is applied to the age 5114, and LV0 is applied to residence 5115. In the processing data 5200, the K value is 2.

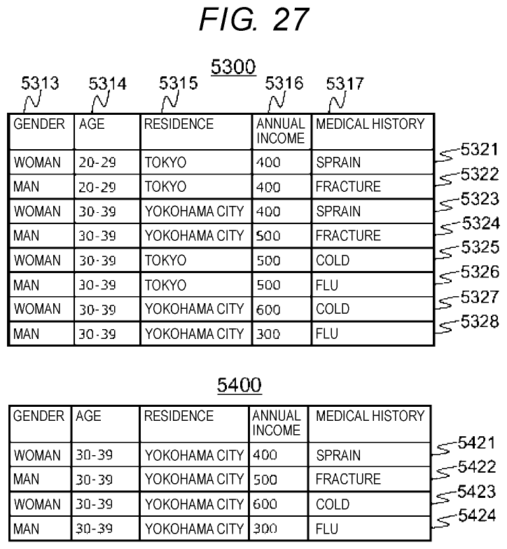

FIG. 27 illustrates configuration information of another processing data 5300 generated by processing the original data 5100. The processing data 5300 shows an example in which the anonymization process is performed on the original data 5100 based upon the generalized hierarchy definition. First, the ID 5111 and the name 5112 of the original data 5100 are deleted. Next, the gender 5113, the age 5114, and the residence 5115 of the original data 5100 are processed by using the processing rule definitions 3100, 3200, and 3300, respectively. This example shows a result in which LV0 is applied to the gender 5113, LV2 is applied to the age 5114, and LV1 is applied to residence 5115. In the processing data 5300, the K value is 2. The reason is that even though records 5321, 5322, 5325, and 5326 are grouped, the number of records becomes 1, respectively. Therefore, processing data 5400 is generated by deleting the records 5321, 5322, 5325, and 5326. In the processing data 5400, the K value is 2.

Hereinafter, an example of generating a processing data providable group will be described as a processing data group in which the processing data 5200 and the processing data 5400 are generated.

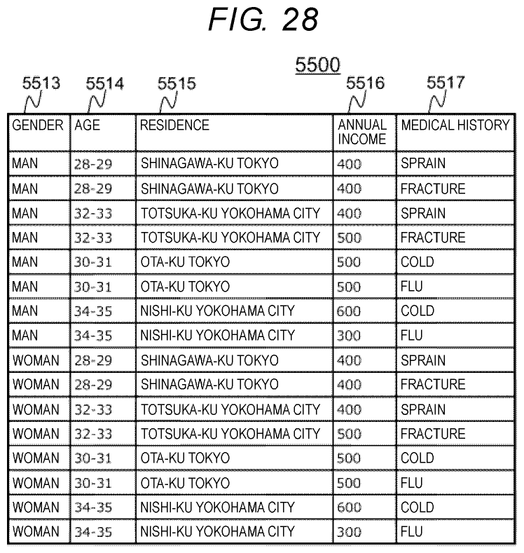

FIG. 28 illustrates configuration information of reprocessing data S500 obtained by reprocessing the processing data 5200 for the collation and confirmation. Here, each attribute is reprocessed so as to become the generalized hierarchy minimum level from the processing content based upon the generalized hierarchy definition executed for the processing data 5200 and the processing data 5400. Specifically, with respect to the processing data 5200, LV1 is applied to the gender 5113, LV1 is applied to the age 5114, and LV0 is applied to the residence 5115. Further, with respect to the processing data 5400, LV0 is applied to the gender 5113, LV2 is applied to the age 5114, and LV1 is applied to the residence 5115. Therefore, LV0 is calculated for the gender 5113, LV1 is calculated for the age 5114, and LV0 is calculated for the residence 5115 as the generalized hierarchy minimum level. By applying this generalized hierarchy minimum level to the processing data 5200, the reprocessing data S500 is generated.

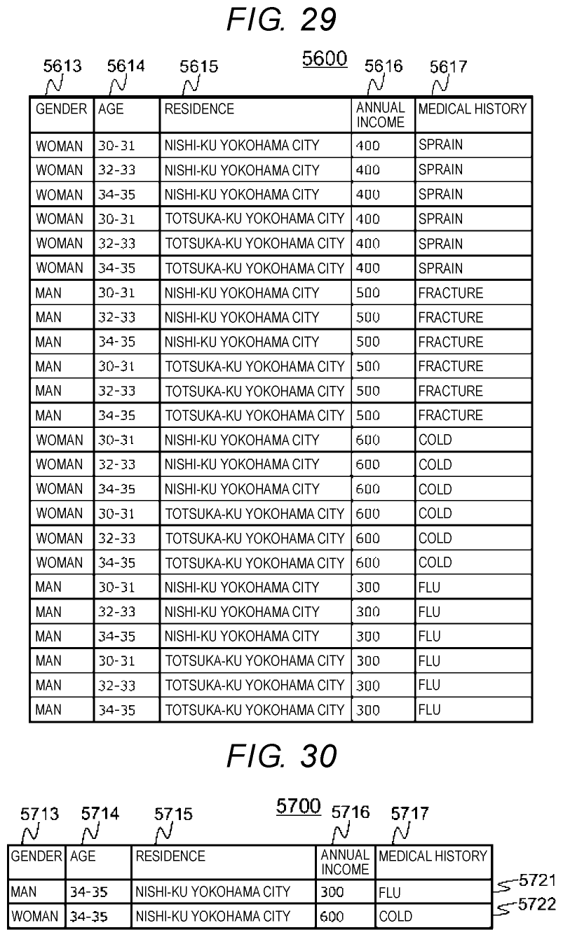

FIG. 29 illustrates configuration information of reprocessing data 5600 obtained by reprocessing the processing data 5400 for the collation and confirmation. The reprocessing data 5600 is generated by applying the above-described generalized hierarchy minimum level to the processing data 5400.

FIG. 30 illustrates configuration information of result data 5700 obtained by combining the reprocessing data 5500 and the reprocessing data 5600. Two records of records 5721 and 5722 can be extracted from a combination result. Accordingly, it can be seen that when the processing data 5200 and the result data 5700 are combined, the anonymity level of the processing data 5200 deteriorates. Specifically, it becomes obvious that a record 5228 of the processing data 5200 and the record 5721 of the result data 5700 correspond to each other, such that the gender of the record 5228 can be identified as a man. In the same manner, it becomes obvious that a record 5227 of the processing data 5200 and the record 5722 of the result data 5700 correspond to each other, such that the gender of the record 5227 can be identified as a woman. As described above, even though the records 5227 and 5228 originally form one group, the group cannot be formed due to these identifications, and as a result, the K value becomes 1. As a result, including the processing data 5200 and the processing data 5400 in one processing data providable group cannot satisfy the data providing condition.

Therefore, by deleting some records of the target processing data, the data providing condition is satisfied. Here, the embodiment considers a case in which some records are deleted from the processing data 5200 and a case in which some records are deleted from the processing data 5400.

In the former case, two records of the records 5227 and 5228 may be deleted from the processing data 5200. After deleting the two records therefrom, it can be confirmed that the K value is 2 with respect to the remaining six records of the processing data 5200. In the latter case, two records of records 5423 and 5424 may be deleted from the processing data 5400. However, after deleting the two records therefrom, it can be confirmed that the K value is 1 with respect to the remaining two records of the processing data 5400. When two records whose K value becomes 1 are further deleted, the number of remaining records of the processing data 5400 becomes 0. Therefore, it can be seen that the latter case cannot satisfy the data providing condition.

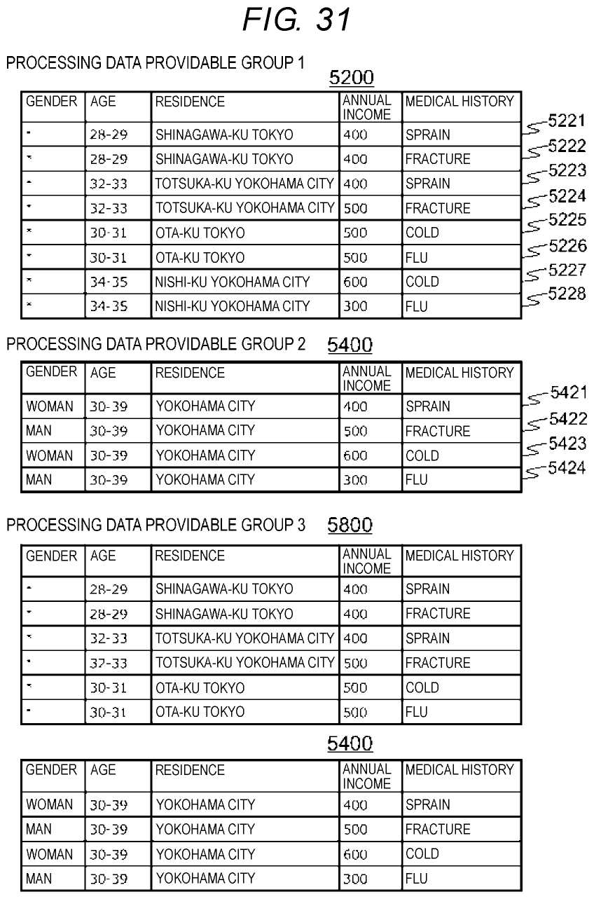

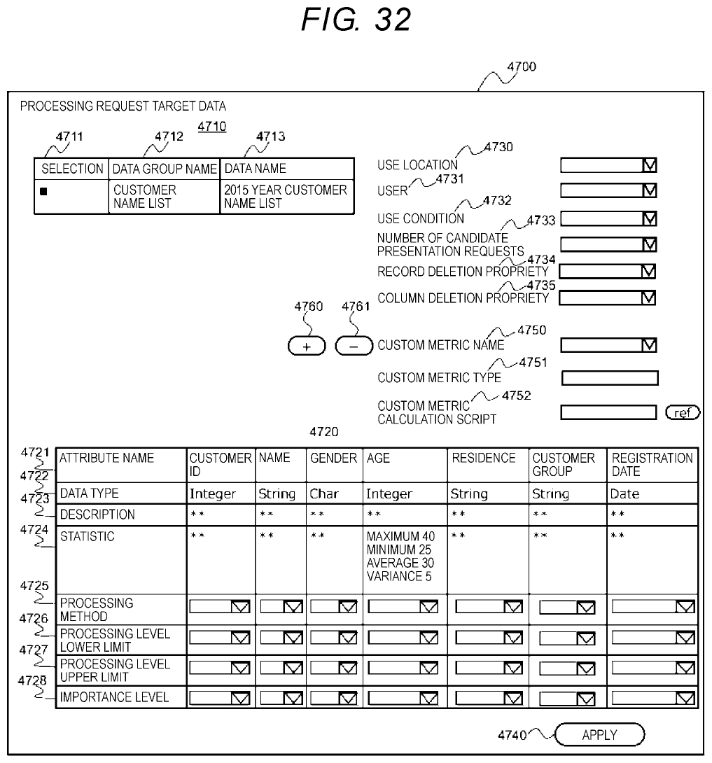

From the above-described results, it can be seen that there are three groups illustrated in FIG. 31 that can be provided as the processing data providable group. FIG. 31 illustrates configuration information of the processing data providable group in this example.

As a processing data providable group 1, there is a group formed of the processing data 5200 alone. Next, as a processing data providable group 2, there is a group formed of the processing data 5400 alone. Finally, as a processing data providable group 3, there is a group formed of two data including processing data 5800 in which some records of the processing data 5200 are deleted and the processing data 5400. These processing data providable groups are registered in the processing data providable group management table 2800, and can be referred to on the processing data list screen 4800.

While the embodiment of the present invention is described above, there are various variations in a method for realizing the present invention and the method is not limited to the above-described method. A method capable of providing equivalent input and output and processing contents may be adopted. The same also applies to another embodiment which will be described later.

### Second Embodiment

In the computer system 1 of the first embodiment, the data user can check usefulness information of the data by referring to the information of the utility metrics 4827 on the processing data list screen 4800. The first embodiment illustrates an example of outputting representative indexes such as a record deficiency rate and an entropy deficiency rate. However, there is a case in which the usefulness cannot be sufficiently determined only by these representative indexes depending on the data use purpose of the data user.

Therefore, in the computer system 1 of a second embodiment, the data user can customize the information of the utility metrics 4827 on the processing data list screen 4800. Specifically, when a data processing request is performed by using the data processing request screen 4700, it is possible to additionally designate information on custom metrics. Hereinafter, FIG. 32 illustrates an update location of the data processing request screen in the second embodiment.

FIG. 32 schematically illustrates the data processing request screen 4700 in the second embodiment. Hereinafter, a difference from the first embodiment will be mainly described.

The data processing request screen 4700 newly adds fields for inputting a custom metric name 4750, a custom metric type 4751, and a custom metric calculation script 4752, and newly adds a button for appropriately adding and deleting the number of these input fields. In the custom metric name 4750, identification information of the custom metrics is inputted. This information is also outputted to the privacy metrics 4826 and the utility metrics 4827 on the processing data list screen 4800. The information is also registered in the privacy metrics 2715 and the utility metrics 2716 in the processing data management table 2700. In the custom metric type 4751, metric type information is inputted. For example, selection and input may be performed from the privacy metrics or the utility metrics. The custom metric calculation script 4752 inputs information that identifies a script file in which logic for calculating a value of the custom metrics is loaded. A target file is registered in the data providing server 11 by using the identification information, and the script can be used when the data processing process and the collation and confirmation process are performed.

The user or role may be given the authority to add, update, refer to, or delete the custom metrics described in the second embodiment.

### Third Embodiment

In the computer system 1 of the first embodiment, the data user can select the processing data providable group from the processing data list screen 4800, select the target processing data from the selected group, and acquire the target processing data. When the processing data providable groups are the same, all the processing data belonging to the group can be acquired. However, when the processing data is acquired and an actual analysis is attempted, there is a possibility that the expected result may not be obtained. In this case, another processing data is searched, but there is a restriction that the processing data providable groups should be the same.

Therefore, in the computer system 1 of a third embodiment, the processing data catalog management function 1127 manages a list of processing data acquired by the data user by using the processing data list screen 4800, confirms whether or not the data user deletes the processing data after acquiring the list of processing data, reflects the above-described confirmation result in the list, and enables the data user to update the selectable processing data providable group based upon a content of the list. As a result, after acquiring any processing data, the data user deletes the acquired data when the processing data cannot achieve the original purpose, thereby making it possible for the data user to search for processing data belonging to another processing data providable group. The data provider confirms the deletion of the data on the data user side, and then uses the processing data belonging to another processing data providable group, thereby making it possible to continuously satisfy the data providing condition. Alternatively, by applying a mechanism that automatically deletes the data acquired by the data user after the lapse of a certain period of time, another processing data may be searchable after the lapse of the certain period of time.

In order to realize the third embodiment, the processing data catalog management function 1127 is required to be able to grasp the list of data acquired by the data user. What is described above can be realized by monitoring all data operations in an environment to be used by the data user, by detecting a deletion operation of the target data, and by reflecting its content in the acquired data list. When a copy operation of the target data is detected, it is required to suppress the copy operation, or to trace existence of copy data and reflect the trace result in the acquired data list.

When acquiring the processing data by using the processing data list screen 4800, and when already acquiring the processing data belonging to any processing data providable group, the data user deletes the acquired data as described above, updates a list of the acquired data managed by the processing data catalog management function 1127, and presses the processing data list display button 4830 on the processing data list screen 4800, thereby making it possible to update the display content of the processing data list table 4820. Accordingly, the data user can select another processing data providable group.

What is claimed is:

1. A data providing server device that registers data from a data provider, receives a data use application and a data use condition registration request from a data user, registers a data providing condition approved by the data provider, confirms a record satisfying the data providing condition in any combination of processing data generated by anonymizing a use target data, and provides the processing data to the data user, the device comprising:
a unit configured to acquire information on a use condition of the use target data from the data user;
a unit configured to receive approval with respect to the use condition from the data provider, and to register the approved use condition as the data providing condition;
a unit configured to generate the processing data by planning and executing a plurality of processing process method candidates satisfying the data providing condition with respect to target data designated by the data user, based upon data registered in advance by the data provider, generalized hierarchy definition information defined with respect to an attribute value of the data, access authority information set in advance with respect to the data, and the data providing condition; and
a unit configured to extract a combination formed of a plurality of any pieces of a generated first processing data group (a second processing data group), to generate collation data by collation thereof, and to register the extracted second processing data group as a processing data providable group when the collation data satisfies the data providing condition.

2. The data providing server device according to claim 1,
wherein the use condition of the use target data acquired from the data user includes at least information on a processing method in each attribute, a range designation of a generalized hierarchy definition level, an importance level, a user, a use location, and the number of candidate presentation requests.

3. The data providing server device according to claim 1, further comprising:
a unit configured to extract a third processing data group obtained by deleting some columns or records of the second processing data group when the collation data does not satisfy the data providing condition, to generate collation data by collation thereof, and to register the extracted third processing data group as the processing data providable group when the collation data satisfies the data providing condition.

4. The data providing server device according to claim 1, further comprising:
a unit configured to calculate and provide privacy metrics and utility metrics of respective processing data candidates when providing a processing data providable group list to the data user.

5. The data providing server device according to claim 1, further comprising:
a unit configured to provide the data user with target data in the processing data providable group selected by the data user from a processing data providable group list.

6. The data providing server device according to claim 1,
wherein the processing process method candidate includes a K-anonymization method, tokenization, and masking.

7. The data providing server device according to claim 1, further comprising:
a unit configured to display a data processing request screen on a data use client machine in response to a request of the data user and to enable the data user to perform a data processing request, to receive an input of a processing method, a processing level lower limit, a processing level upper limit, and an importance level in at least each attribute of processing target data, and to receive and register an input related to record deletion propriety and column deletion propriety.

8. The data providing server device according to claim 7, further comprising:
a unit configured to add an input field of the data processing request inputted by the data user on the data processing request screen displayed on the data use client machine in response to the request of the data user, to add a field for inputting a custom metric name, a custom metric type, and a custom metric calculation script so as to customize utility metric information, and to receive and register an input by the data user.

9. The data providing server device according to claim 5, further comprising:
a unit configured to manage processing data in an acquisition data list when the processing data is acquired in the processing data providable group selected by the data user from the processing data providable group list, to reflect deletion of the processing data in the acquisition data list when the processing data acquired by the data user is deleted, to suppress an operation of copying the processing data acquired by the data user, or to trace existence of copy data and reflect a trace result in the acquisition data list, and to enable the data user to select another processing data providable group after confirming that all the processing data is deleted from the acquisition data list.

10. A data providing method, comprising:
a step of receiving, by a computer system, a data registration request from a data provider and registering data;
a step of providing, by the computer system, a registered data list to a data user according to a request from the data user;
a step of receiving, by the computer system, a notification of a data use condition for using the data after the data user selects a use target data from the data list;
a step of transmitting, by the computer system, an approval request to the data provider for allowing to confirm the data use condition of the use target data and to determine the availability of the use target data, and of receiving, by the computer system, a response from the data provider;
a step of receiving, by the computer system, the data processing condition of the use target data transmitted by the data user based upon a use approval content of the use target data;
a step of planning, by the computer system, a combination of processing data generation patterns based upon a data processing condition content;
a step of executing, by the computer system, a data processing process on the use target data for each combination of the planned processing data generation patterns, and of generating and registering, by the computer system, processing data that achieves a data providing condition in which the data use condition is approved;
a step of extracting, by the computer system, a combination formed of a plurality of any pieces of a generated first processing data group (a second processing data group), of generating, by the computer system, collation data by collation thereof, and of registering, by the computer system, the extracted second processing data group as a processing data providable group when the collation data satisfies the data providing condition;
a step of providing, by the computer system, the data user with a registered processing data providable group list in response to a processing data list request by the data user; and
a step of providing, by the computer system, the data user with target data in the processing data providable group selected by the data user from the processing data providable group list.

11. The data providing method according to claim 10, further comprising:
a step of extracting, by the computer system, a third processing data group obtained by deleting some columns or records of the second processing data group when the collation data does not satisfy the data providing condition, of generating, by the computer system, collation data by collation thereof, and of registering, by the computer system, the extracted third processing data group as the processing data providable group when the collation data satisfies the data providing condition.

12. The data providing method according to claim 10,
wherein the data use condition of the use target data notified from the data user includes at least information on a processing method in each attribute, a range designation of a generalized hierarchy definition level, an importance level, a user, a use location, and the number of candidate presentation requests.

13. The data providing method according to claim 10, further comprising:
a step of calculating and providing privacy metrics and utility metrics of respective processing data candidates when providing a processing data providable group list to the data user.
